(19) United States
(12) Patent Application Publication
(10) Pub. No.: US 2026/0306346 A1
(43) Pub. Date: Oct. 8, 2026

(54) Tissue Massagers and Related Methods

(71) Applicant: Victor Manuel GONZALEZ, Vancouver, WA (US)

(72) Inventor: Victor Manuel GONZALEZ, Vancouver, WA (US)

(21) Appl. No.: 19/377,427

(22) Filed: Nov. 3, 2025

Related U.S. Application Data
(60) Provisional application No. 63/715,399, filed on Nov. 1, 2024.

(51) Int. Cl. A61H 15/00

(52) U.S. Cl. CPC A61H 15/0092; A61H 2015/0014

(57) ABSTRACT

Tissue massagers and related methods of use and/or methods of manufacture are disclosed herein. The tissue massager may comprise a handle and a roller assembly. The roller assembly may comprise a roller bracket having first and second bracket arms extending from respective sides of a central portion of the roller bracket. Each bracket arm may comprise an aperture. A roller with a concave surface may be positioned between the bracket arms. A roller may extend laterally outward from each of the bracket arms.

### CROSS REFERENCE TO RELATED APPLICATIONS

This application claims priority to U.S. Provisional Application 63/715,399 filed on Nov. 1, 2024.

### BACKGROUND OF THE INVENTION

The present disclosure relates to tissue massagers and related methods.

Current tissue massagers on the market are neither sufficiently adjustable, nor easily applied to multiple tissues and/or locations of particular tissues to meet the massage needs of users, especially users involved in vigorous weightlifting and/or other athletic training. Accordingly, a need exists for novel tissue massagers that provide added accommodation, by design, so as to be sufficiently easily usable to be easily applied to multiple different tissues and/or locations of particular tissues of users. Accordingly, a need also exists for novel related methods of use and methods of manufacture.

### SUMMARY OF THE INVENTION

In some embodiments, a tissue massager is provided. For example, as will be described in connection with FIGS. 1-11B, such a tissue massager may include a handle, a first roller assembly coupled to a first end of the handle, and a second roller assembly coupled to a second end of the handle as shown and/or described anywhere in this disclosure.

In some other embodiments, another tissue massager is provided. For example, as will be described in connection with at least FIGS. 12-20 and 23-25, such a tissue massager may include a handle and a first roller assembly coupled to a first end of the handle as shown and/or described anywhere in this disclosure. The first and/or second roller assemblies may comprise two rollers, three rollers, four rollers, or more than four rollers.

In yet other embodiments, yet another tissue massager is provided. For example, as will be described in connection with FIGS. 26-33, such a tissue massager may include a handle and a roller assembly, having three rollers, coupled to a first end of the handle as shown and/or described anywhere in this disclosure.

In yet other embodiments, yet another tissue massager is provided. For example, as will be described in connection with FIGS. 34-40, such a tissue massager may include a handle and a roller assembly, having one roller, coupled to a first end of the handle as shown and/or described anywhere in this disclosure.

The roller surfaces of any or all the rollers of a roller assembly may be flat or concave. Embodiments of roller assemblies having three rollers with concave surfaces such as illustrated in FIGS. 23, 24 and 26-33 have been found advantageous both for massage effectiveness and manufacturing efficiency. Another embodiment not shown in the figures has three rollers with a concave surface roller in the middle and flat surface rollers on either side of the middle concave surface roller.

In some embodiments, a method of utilizing a tissue massager is provided. For example, as will be described in connection with FIG. 21, such a method may include pressing at least one roller of a first roller assembly of a tissue massager against a tissue of a user to provide a first desired amount of pressure to the tissue while holding a handle of the tissue massager. Such a tissue massager may be any tissue massager explicitly described, or implicitly intimated, by this disclosure. Such a method may include rolling the at least one roller along the tissue while the at least one roller is providing the first desired amount of pressure to the tissue while holding a handle of the tissue massager.

In some embodiments, such a method may include adjusting the orientation of the tissue massager in the user's hand such that a direction of extension of the handle in the user's hand is rotated 180 degrees, end-over-end, compared to an orientation in previous steps, thereby placing a second roller assembly in a position to massage the tissue or a different tissue. Such a method may include pressing the second plurality of rollers of the second roller assembly of the tissue massager against the same tissue or the different tissue of the user to provide a second desired amount of pressure to the same tissue or to the different tissue while holding the handle of the tissue massager. Such a method may include rolling the second plurality of rollers along the tissue while the rollers are providing the second desired amount of pressure to the same tissue or to the different tissue while holding a handle of the tissue massager.

In some embodiments, a method of manufacturing a tissue massager is provided. For example, as will be described in connection with any figure herein, such a method may include forming, by any appropriate means, and as either a singular, monolithic part or as one or more separate parts, one or more of a handle, a first neck, first and second bracket arms of the first neck, and roller shafts first and second bracket arms. Some embodiments further include forming, by any appropriate means, and as either a part of the singular, monolithic part or as one or more separate parts, a second neck, first and second bracket arms of the second neck, and roller shafts of the first and second bracket arms. Such a method may include forming rollers configured to be disposed on a respective roller shaft of the tissue massager. Such a method may include assembling all separate parts of the massager.

In yet other embodiments, such a method of manufacture may include forming, by any appropriate means, and as either a singular, monolithic part or as one or more separate parts, one or more of a handle; a roller bracket assembly comprising a central portion, and first and second bracket arms extending from sides of the central portion; first, second and third rollers each having a respective concave curvature, at least one roller axle, and first and second bushings, as described or intimated anywhere in this disclosure.

### BRIEF DESCRIPTION OF DRAWINGS

A more complete appreciation of the subject matter of the present disclosure and of the various advantages thereof can be realized by reference to the following detailed description in which reference is made to the accompanying drawings in which:

FIG. 1 is a top perspective view of a tissue massager, according to some example embodiments;

FIG. 2 is a bottom perspective view of the tissue massager of FIG. 1;

FIG. 3 is a Bottom view of the tissue massager of FIG. 1;

FIG. 4 is a Top view of the tissue massager of FIG. 1;

FIG. 5 is a first side view of the tissue massager of FIG. 1;

FIG. 6 is another side view of the tissue massager of FIG. 1;

FIG. 7 is a first end view of the tissue massager of FIG. 1;

FIG. 8 is another end view of the tissue massager of FIG. 1;

FIGS. 9A and 9B are side views of the tissue massager of FIG. 1 showing the parameters of extension of the roller assemblies form the handles in some embodiments;

FIGS. 10A, 10B, 10C, and 10D illustrate various sizes of roller assemblies and angular orientations of the rollers within a roller assembly in some embodiments;

FIGS. 11A and 11B illustrate end views of the tissue massager of FIG. 1 illustrating relative angular orientations of roller assemblies on the handle in some embodiments;

FIG. 12 is a bottom view of another tissue massager, according to some example embodiments;

FIG. 13 is a top view of the tissue massager of FIG. 12;

FIG. 14 is a first side view of the tissue massager of FIG. 12;

FIG. 15 is another side view of the tissue massager of FIG. 12;

FIG. 16 is a first end view of the tissue massager of FIG. 12;

FIG. 17 is another end view of the tissue massager of FIG. 12;

FIG. 18 is a top perspective view of the tissue massager of FIG. 12;

FIG. 19 is a bottom perspective view of the tissue massager of FIG. 12;

FIG. 20 is a top exploded perspective view of some portions of a tissue massager, according to some example embodiments;

FIG. 21 is a flowchart related to a method of utilizing a tissue massager, according to some example embodiments;

FIG. 22 is a flowchart related to a method of manufacturing a tissue massager, according to some example embodiments;

FIG. 23 is a top perspective view of another tissue massager, according to some embodiments;

FIG. 24 is an end view of the tissue massager of FIG. 23;

FIG. 25 is a top exploded perspective view of some portions of a tissue massager, according to some example embodiments;

FIG. 26 is a top perspective view of another tissue massager, according to some example embodiments;

FIG. 27 is an exploded top perspective view of the tissue massager of FIG. 26;

FIG. 28 is a front view of the tissue massager of FIG. 26;

FIG. 29 is a rear view of the tissue massager of FIG. 26;

FIG. 30 is a first side view of the tissue massager of FIG. 26;

FIG. 31 is a second side view, opposite the view of FIG. 30, of the tissue massager of FIG. 26;

FIG. 32 is a bottom view of the tissue massager of FIG. 26;

FIG. 33 is a top view of the tissue massager of FIG. 26;

FIG. 34 is a top perspective view of another tissue massager, according to some example embodiments;

FIG. 35 is a front view of the tissue massager of FIG. 34;

FIG. 36 is a rear view of the tissue massager of FIG. 34;

FIG. 37 is a first side view of the tissue massager of FIG. 34;

FIG. 38 is a second side view, opposite the view of FIG. 30, of the tissue massager of FIG. 34;

FIG. 39 is a top view of the tissue massager of FIG. 34; and

FIG. 40 is a bottom view of the tissue massager of FIG. 34.

FIG. 41A is a top view of another embodiment of a tissue massager.

FIG. 41B is a bottom view of the tissue massager of FIG. 41A.

FIG. 42 is top perspective view of a tissue massager embodiment.

FIG. 43 is a top view of the tissue massager of FIG. 42.

FIG. 44 is a bottom view of the tissue massager of FIG. 42.

FIG. 45 is a left side view of the tissue massager of FIG. 42.

FIG. 46 is a right side view of the tissue massager of FIG. 42.

FIG. 47 is a rear view of the tissue massager of FIG. 42.

FIG. 48 is a front view of the tissue massager of FIG. 42.

FIG. 49 is top perspective view of another tissue massager embodiment.

FIG. 50 is a top view of the tissue massager of FIG. 49.

FIG. 51 is a bottom view of the tissue massager of FIG. 49.

FIG. 52 is a left side view of the tissue massager of FIG. 49.

FIG. 53 is a right side view of the tissue massager of FIG. 49.

FIG. 54 is a rear view of the tissue massager of FIG. 49.

FIG. 55 is a front view of the tissue massager of FIG. 49

### DETAILED DESCRIPTION OF THE INVENTION

The present disclosure relates to tissue massagers and/or related methods.

### Example Tissue Massager 100

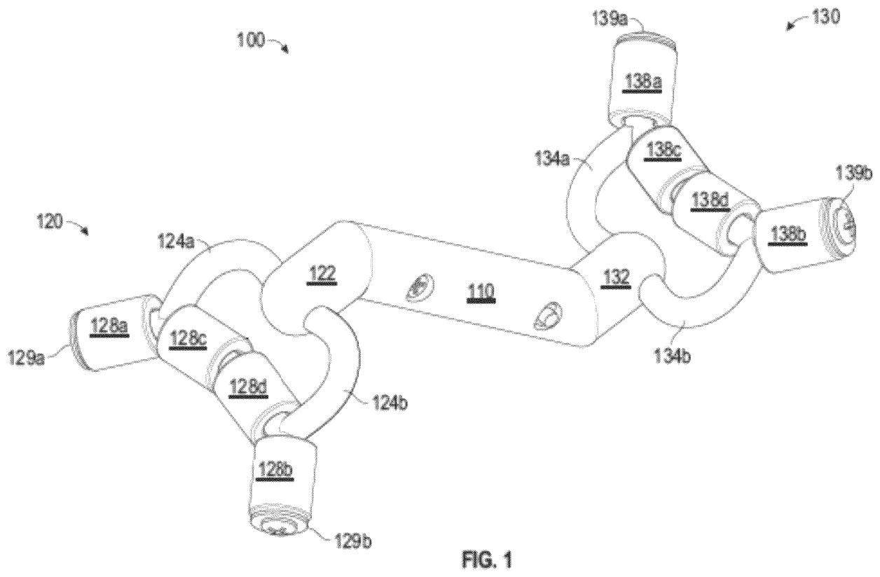

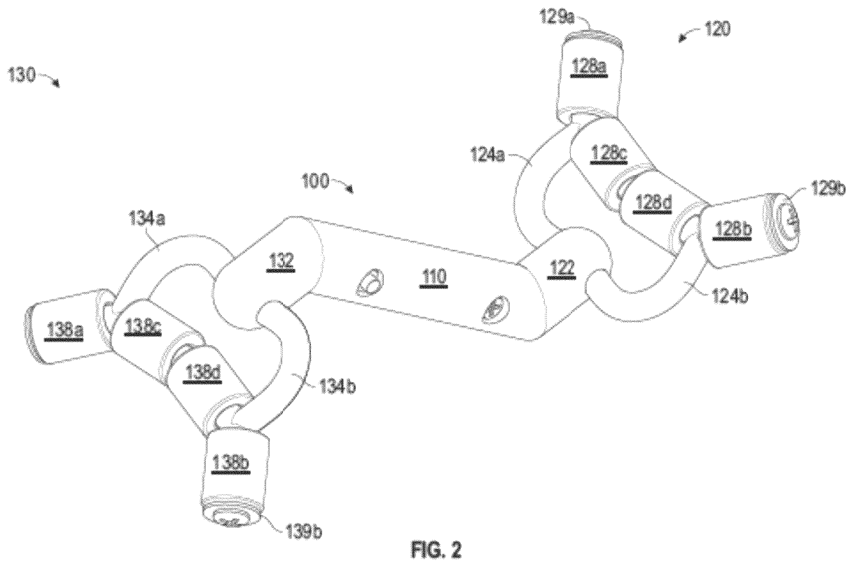

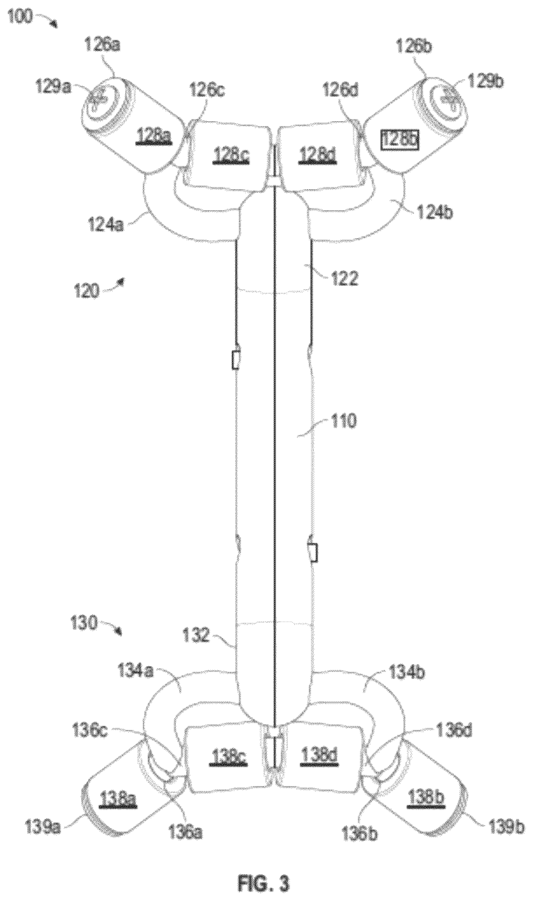

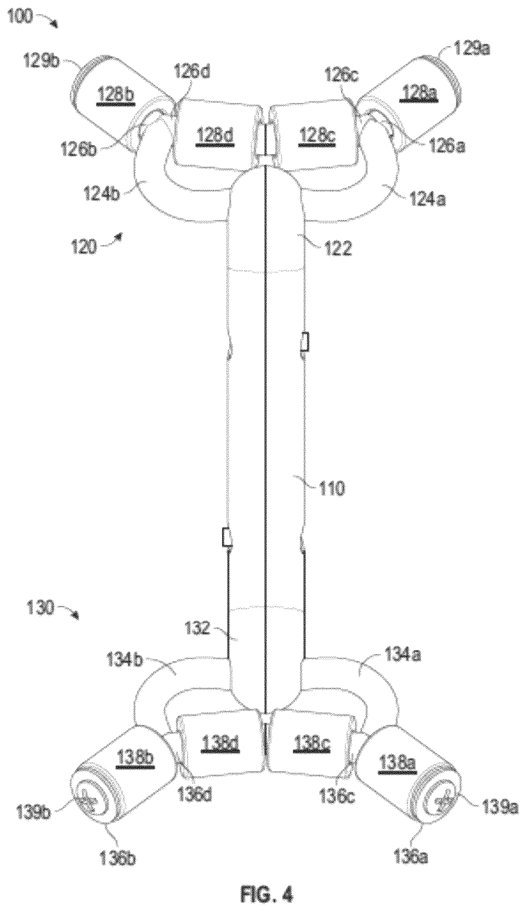

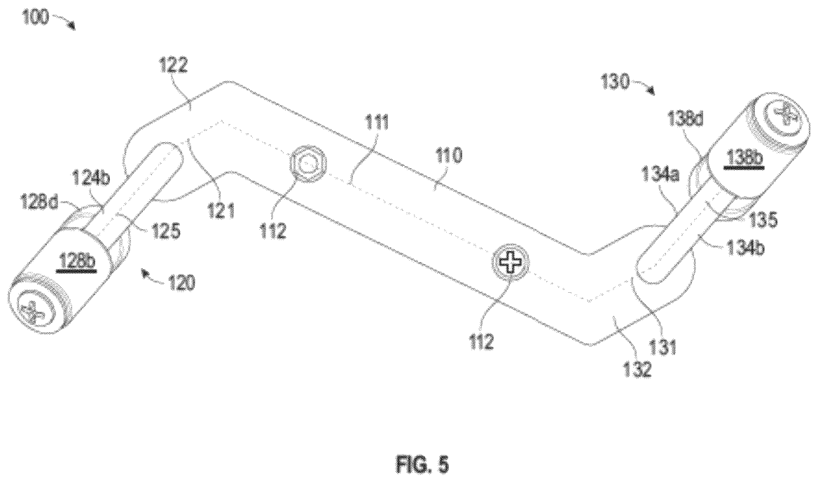

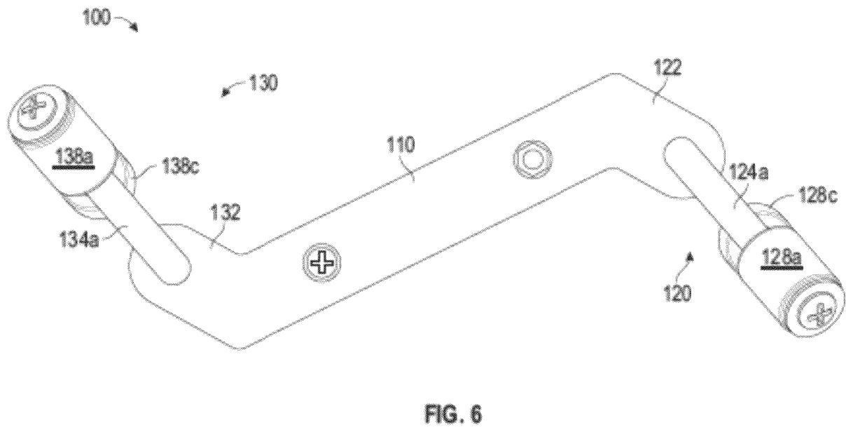

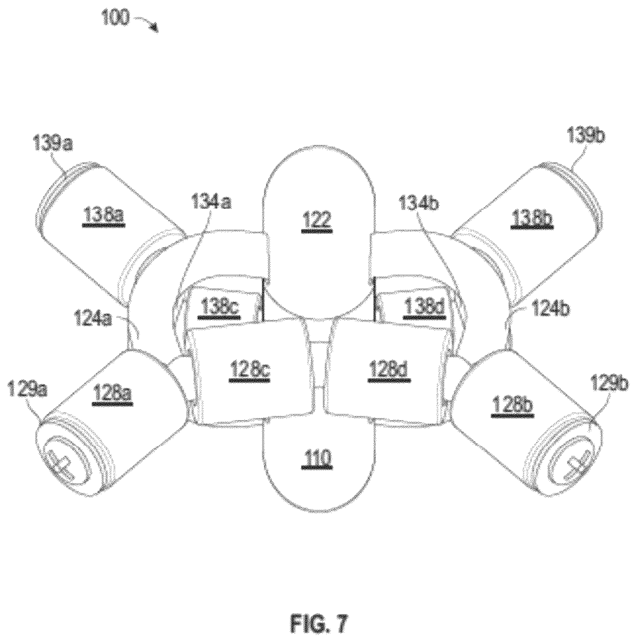

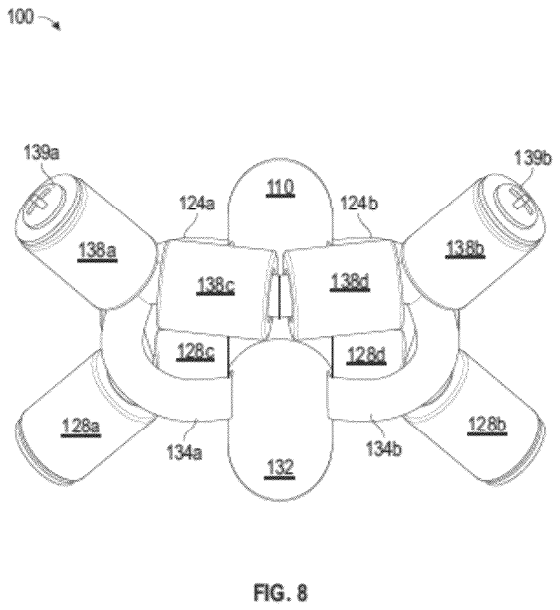

FIG. 1 is a top perspective view of a tissue massager 100, according to some example embodiments. FIGS. 2-8 illustrate various other views of tissue massager 100 of FIG. 1. Tissue massager 100 includes a handle 110 having a first direction of extension 111 (see, e.g., FIG. 5), a first roller assembly 120 coupled to a first end of handle 110, and a second roller assembly 130 coupled to a second end of handle 110. While the present disclosure is not so limited, handle 110 may have a substantially cylindrical form. Further, while the present disclosure is not so limited, in some embodiments, handle 110 may be formed of separate and/or mirroring portions (e.g. left and right halves molded, printed, forged, carved or formed in any other way). In some such embodiments, see e.g., FIG. 5, such separate and/or mirroring portions may be fixed to one another via one or more fasteners 112, e.g., screw and nut combination or any other suitable type of fastener. The two portions may also be fixed together by gluing, melting, or snapping together with integral snapping engagement features.

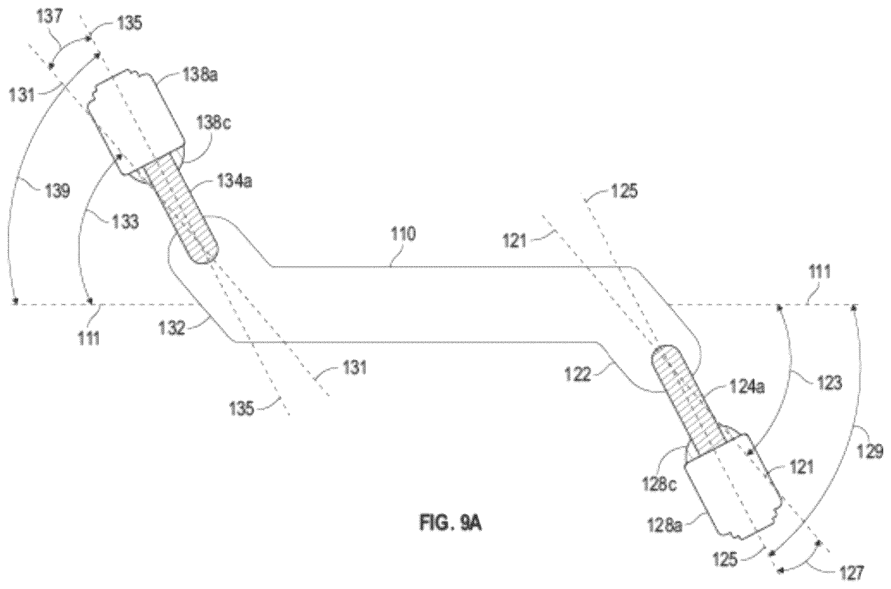

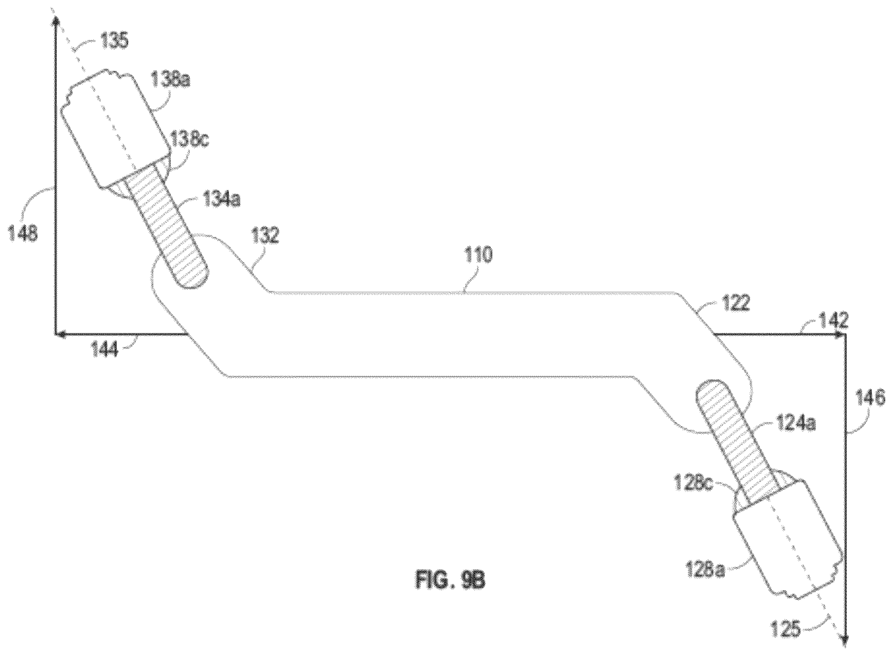

First roller assembly 120 includes a first neck 122 having a second direction of extension 121 and extending from the first end of handle 110 at a first angle 123 (see FIG. 9A) with respect to first direction of extension 111. In some embodiments, first angle 123 is between 0° and 90°. In some embodiments, first angle 123 is between 30° and 60°. In some embodiments, first angle 123 is substantially 45°.

First roller assembly 120 has a first bracket arm 124a coupled to a first side of first neck 122, and a second bracket arm 124b coupled to a second side of first neck 122 opposite the first side. In some embodiments, first bracket arm 124a and second bracket arm 124b are disposed in a same plane 125 (see FIG. 9A) that is, itself, disposed at a second angle 127 (see FIG. 9A) with respect to second direction of extension 121 of first neck 122 of first roller assembly 120.

A first roller shaft 126a of first roller assembly 120 extends laterally from a distal end of first bracket arm 124a and a second roller shaft 126c of first roller assembly 120 extends medially from the distal end of first bracket arm 124a. A third roller shaft 126d of the first roller assembly extends medially from a distal end of second bracket arm 124b and a fourth roller shaft 126b of first roller assembly 120 extends laterally from the distal end of second bracket arm 124b.

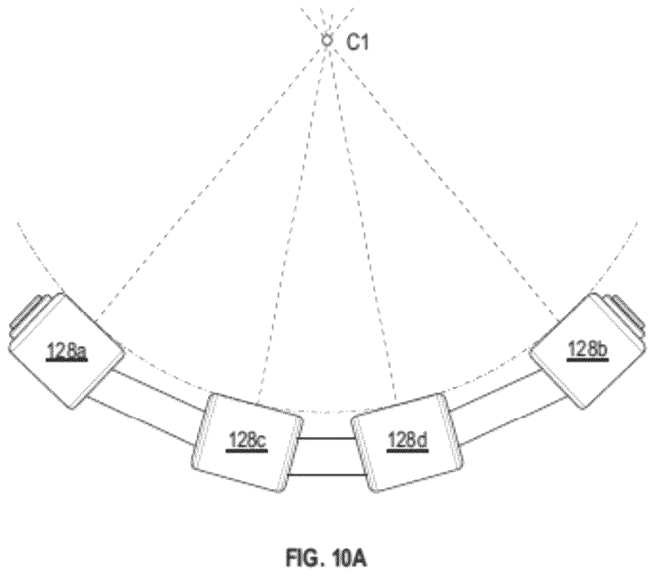

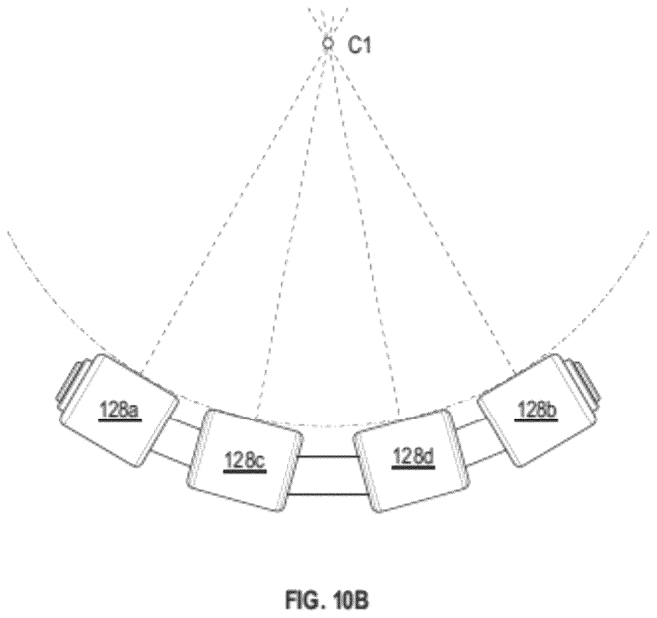

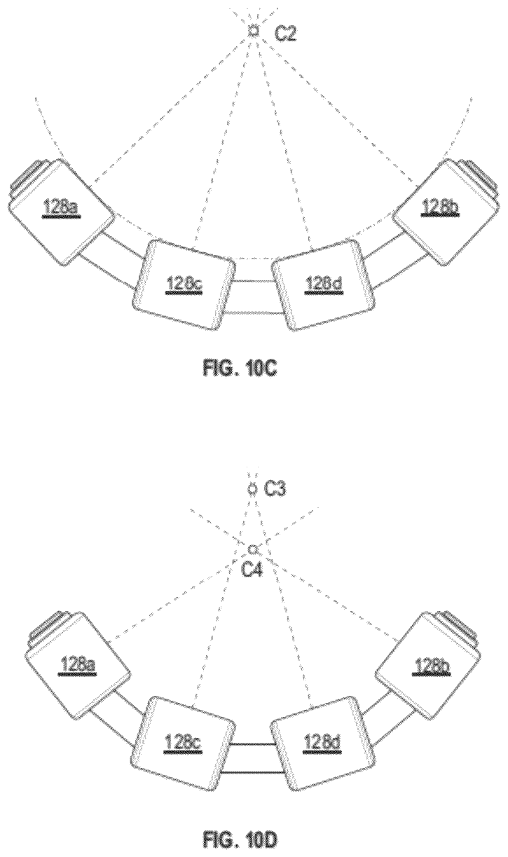

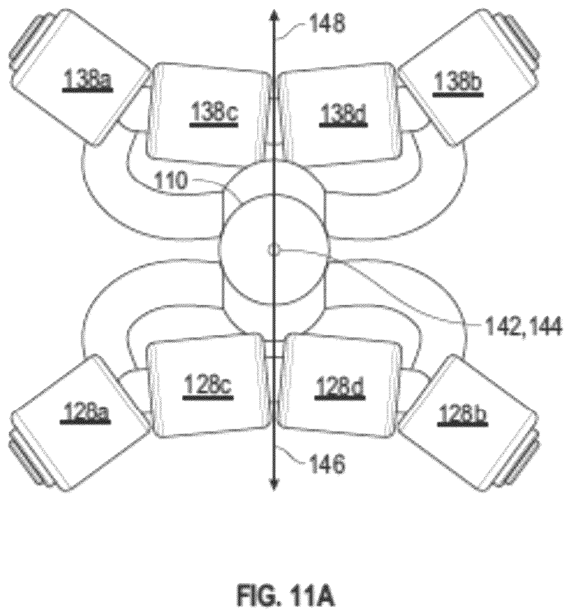

First roller assembly 120 includes four rollers 128a, 128b, 128c, 128d, each disposed on a respective one of roller shafts 126a-126d. In this example, each roller 128a-128d has a substantially cylindrical form, although different surface shapes, such as concave, may also be utilized. As illustrated in at least FIGS. 10A-10D, each roller shaft 126a-126d, and so each roller 128a-128d, may be disposed at a different angle. The direction of extension of each of roller shafts 126a-126d defines an axis of rotation of each of rollers 128a-128d. Dashed lines (see FIGS. 10A-10D) illustrate a direction of applied pressure for each of rollers 128a-128d, which is generally normal to the surface of each of rollers 128a-128d and may each point in different directions.

While the present disclosure is not so limited, as shown in FIGS. 10A, 10B, and 10C, the directions of applied pressure for each of rollers 128 a-128d may converge at a single focal point C1 or C2. In some embodiments, such a configuration may allow proper, simultaneous and/or distributed application of massaging forces, by each of rollers 128a-128b, to muscles and/or other tissues of a body part disposed against rollers 128a-128d (e.g., a portion of an arm or a portion of a leg).

In some embodiments, roller shaft 126c and roller shaft 126d extend to meet one another at a midline of tissue massager 100 that is coplanar with first direction of extension 111 of handle 110. Accordingly, respective directions of extension of roller shaft 126c and roller shaft 126d may be offset from one another by a desired angle. In yet other embodiments, roller shaft 126c and roller shaft 126d are formed, as a single roller unit extending essentially from one of first and second bracket arms 124a, 124b toward, or substantially to, the other of first and second bracket arms 124a, 124b.

In some embodiments, first bracket arm 124a, second bracket arm 124 b, and the respective directions of extension (e.g., dashed lines in FIGS. 10A-10D) of each of roller shafts 126a-126d are disposed in the same plane 125 (see, e.g., the plane coincident with axis 125 in FIG. 9A and extending normal to the plane of the page in the side view of FIG. 9A).

Second roller assembly 130 includes a first neck 132 having a third direction of extension 131 and extending from the second end of handle 110 at a second angle 133 with respect to first direction of extension 111. In some embodiments, this second angle 133 is between 0° and 90°. In some embodiments, this second angle 133 is between 30° and 60°. In some embodiments, this second angle 133 is substantially 45°.

Second roller assembly 130 has a first bracket arm 134a coupled to a first side of second neck 132, and a second bracket arm 134b coupled to a second side of second neck 132 opposite the first side. In some embodiments, first bracket arm 134a and second bracket arm 134b are disposed in a same plane 135 that is, itself, disposed at an angle 137 with respect to direction of extension 131 of second neck 132 of second roller assembly 130 in a manner analogous to the first roller assembly 120.

A first roller shaft 136a of second roller assembly 130 extends laterally from a distal end of first bracket arm 134a and a second roller shaft 136c of second roller assembly 130 extends medially from a distal end of second bracket arm 134b. A third roller shaft 136d of the second roller assembly 130 extends medially from a distal end of second bracket arm 134b and a fourth roller shaft 136b of second roller assembly 130 extends laterally from the distal end of second bracket arm 134b.

Second roller assembly 130 includes four rollers 138a-138d, each disposed on a respective one of roller shafts 136a-136d. In this example, each roller 138a-138d has a substantially cylindrical form, although different surface shapes, such as concave, may also be utilized. As illustrated in at least FIGS. 10A-10D, each roller shaft 136a-136d, and so each roller 138a-138d, may be disposed at a different angle. The direction of extension of each of roller shafts 136a-136d defines an axis of rotation of each of rollers 138a-138d. Dashed lines (see FIGS. 10A-10D) illustrate a direction of applied pressure for each of rollers 138a-138d, which is generally “normal” to the surface of each of rollers 138a-138d.

While the present disclosure is not so limited, in FIGS. 10A, 10B, and 10C, the directions of applied pressure for each of rollers 138a-138d may converge at a single focal point C1 or C2. In some embodiments, focal point C2 may be a different distance from each of rollers 138a-138d than focal point C1 is from each of rollers 128a-128d. Accordingly, and as explained further below with reference to FIGS. 10A-10D, such a configuration may allow proper, simultaneous and/or distributed application of massaging forces, by each of rollers 138a-138d, to muscles and/or other tissues of another differently sized body part than roller assembly 120 that may be disposed against rollers 128a-128d.

In some embodiments, roller shaft 136c and roller shaft 136d extend to meet one another at a midline of tissue massager 100 that is coplanar with first direction of extension 111 of handle 110. Accordingly, respective directions of extension of roller shaft 136c and roller shaft 136d may be offset from one another by a desired angle. In yet other embodiments, roller shaft 136c and roller shaft 136d are formed, as a single roller unit extending essentially from one of first and second bracket arms 134a, 134b toward, or substantially to, the other of first and second bracket arms 134a, 134b.

In some embodiments, one or more of the roller shafts 126a-d, 136a-d may be flexible so that when a roller assembly 120 or 130 is pressed against tissue such as an arm or leg there is some compliance to the roller assembly under the force applied by the user. This can help the roller assembly engage the tissues being massaged more effectively. This feature may be accomplished by using a flexible polymer material for some or all of roller shafts 126a-d, 136a-d, especially the outer roller shafts 126a, 126b, 136a, 136b. In some embodiments, flexibility is provided locally to the junctions of roller shafts 126a/126c, 126b/126d, 136a/136c, and 136b/136d. Hinging or other mechanical methods to provide this compliant roller assembly feature may also be used.

In some embodiments, first bracket arm 134a, second bracket arm 134b, and the respective directions of extension (e.g., dashed lines in FIGS. 10A-10D) of each of roller shafts 136a-136b are disposed in the same plane 135 (see, e.g., the plane coincident with axis 135 in FIG. 9A and extending normal to the plane of the page in the side view of FIG. 9A).

FIG. 9A illustrates and defines angles of extension of roller assemblies 120 and 130 from handle 110. Neck 122 may extend from the main body of the handle 110 along an axis 121 which forms an angle 123 with respect to the axis 111 of the main body of the handle 110. Similarly, neck 132 may extend from the main body of the handle 110 along an axis 131 which forms an angle 133 with respect to the axis 111 of the main body of the handle 110. Bracket arms 124a and 124b may extend from neck 122 along an axis 125 and bracket arms 134a and 134b may extend from neck 132 along an axis 135. Axis 125 forms an angle 129 with respect to the axis 111 of the main body of the handle 110 and axis 135 forms an angle 139 with respect to the axis 111 of the main body of the handle 110. The two axes 121 and 125 form an angle 127 relative to each other, and the two axes 131 and 135 form an angle 137 with respect to each other.

Angles 123 and 133 may be the same or different, and as noted above may in some embodiments range from 0 to 90 degrees, with 30 to 60 degrees having been found suitable in some embodiments. Angles 129 and 139 may also be the same or different and may also range from 0 to 90 degrees. Angles 129 and 139 may have the same or substantially the same value (substantially the same being within 10 degrees of each other) as angles 123 and 133 respectively, which means the bracket arms extend substantially directly straight from the neck, and one or both the angles 127 and 137 are less than 10 degrees. Angles 129 and 139 may be smaller than 123 and 133 respectively in some embodiments. Angles 129 and 139 may be within plus or minus 30 degrees of angles 123 and 133 respectively in some embodiments.

FIG. 9B shows that axis 125 extends with a component in a first direction 142 parallel to the axis 111 of the main body of the handle 110 and with a component in a second direction 146 perpendicular to the axis 111 of the main body of the handle 110. Similarly, axis 135 extends with a component in a first direction 144 parallel to the axis 111 of the main body of the handle 110 and with a component in a second direction 148 perpendicular to the axis 111 of the main body of the handle 110.

FIGS. 10A-10D illustrate different configurations of roller assembly in some embodiments. Although these Figures refer to rollers 128a-d of roller assembly 120 these configurations and the related principles are equally applicable to any roller assembly, including roller assemblies 130, 220, and 320. In FIG. 10A, the centers of the rolling surfaces of the rollers lie on a substantially circular arc with radius C1. In FIG. 10B, the centers of the rolling surfaces of the rollers also lie on a substantially circular arc with radius C1 but the rollers are spaced closer together. In FIG. 10C, the centers of the rolling surfaces of the rollers lie on a substantially circular arc with radius C2 which is less than the example C1 in FIGS. 10A and 10B. Accordingly, different roller assemblies can be larger or smaller based on the arc radius (or radii as in FIG. 10D) that the rollers lie on or by the spacing between rollers on arcs of the same radius. Roller assembly size can also vary based on the size of the rollers, where generally smaller arcs and closer spacing would be associated also with smaller rollers. As shown in FIG. 10D, the roller surfaces of a roller assembly may not be aligned on a common circular arc. In the example of FIG. 10D, the inner rollers 128c and 128d lie on an arc with radius C3 which is a larger radius than the arc radius C4 that the outer rollers 128a and 128b reside on. In this embodiment, the outer rollers wrap a little tighter than the inner rollers.

For embodiments with roller assemblies on both ends of a handle such as shown in FIGS. 1-8, second roller assembly 130 may be configured differently than the first roller assembly 120. For example, the second roller assembly 130 may have a different size than first roller assembly 120 such that first roller 120 is sized to massage a first body part and second roller 130 is sized to massage a second body part having a different size and/or shape compared to the first body part. Moreover, because first and second roller assemblies 120, 130 are disposed to extend in opposite directions and from opposite ends of handle 110, first roller assembly 120 may be specifically configured to be applied to a tissue while being held by handle 110 and then, with or without releasing handle 110, the user may alternatively apply second roller assembly 130 to the same or a different tissue by merely rotating tissue massager 100 such that direction of extension 111 rotates end-over-end, thereby placing second roller assembly 130 in position to massage the same or different tissue.

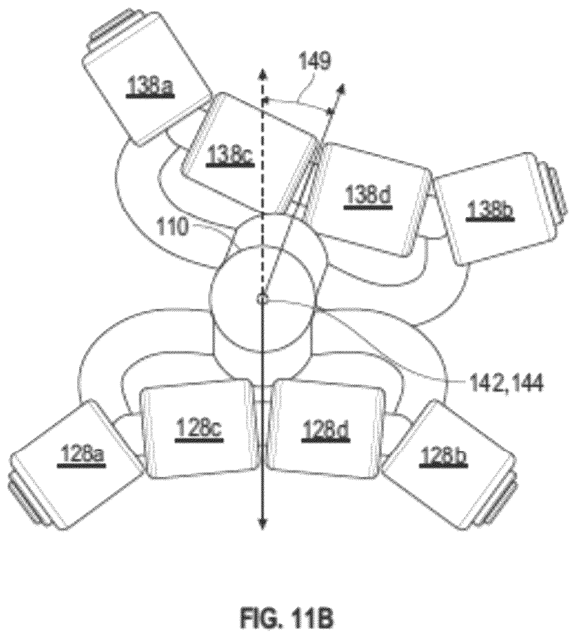

FIGS. 11A and 11B show in end views how the component of the extension of the roller assemblies that is perpendicular to the axis 111 of the main body of the handle 110 can be in or out of alignment with each other. In some embodiments, the extensions are aligned but point in opposite directions such as shown in FIG. 11A. In other embodiments, the extensions are not oppositely aligned as in FIG. 11A but their extensions perpendicular to the axis 111 of the main body of handle 110 have orientations separated by an angle 149. This angle 149 may be any angle between 0 to 180 degrees, wherein the latter 180 degrees case it means in the context of roller extensions 120 and 130 of the embodiment of FIGS. 1-8 that both roller extensions extend perpendicular to the axis 111 of the handle 110 in the same direction. In some embodiments, such as shown in FIGS. 1-8, angle 149 is less than 10 degrees. In other embodiments, it is 35 to 55 degrees. In still other embodiments, it is 80 to 100 degrees.

### Example Tissue Massager 200

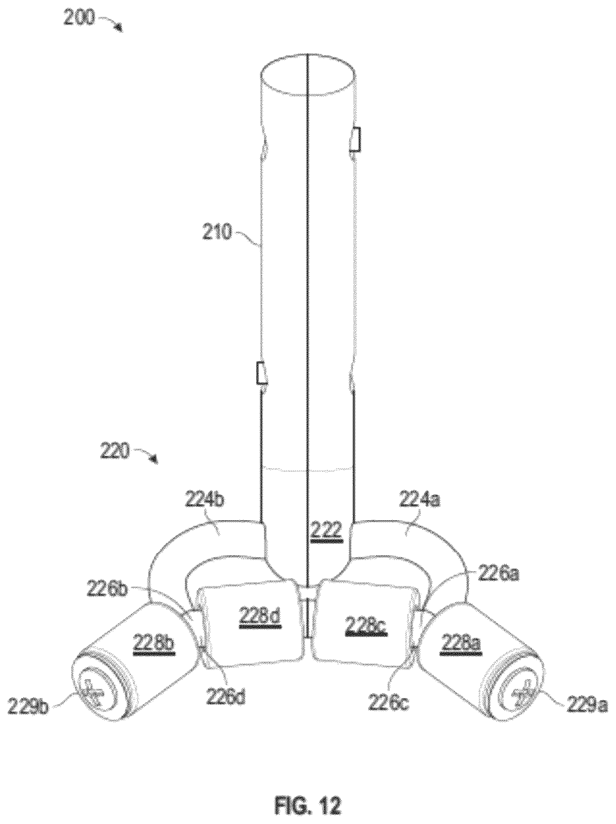

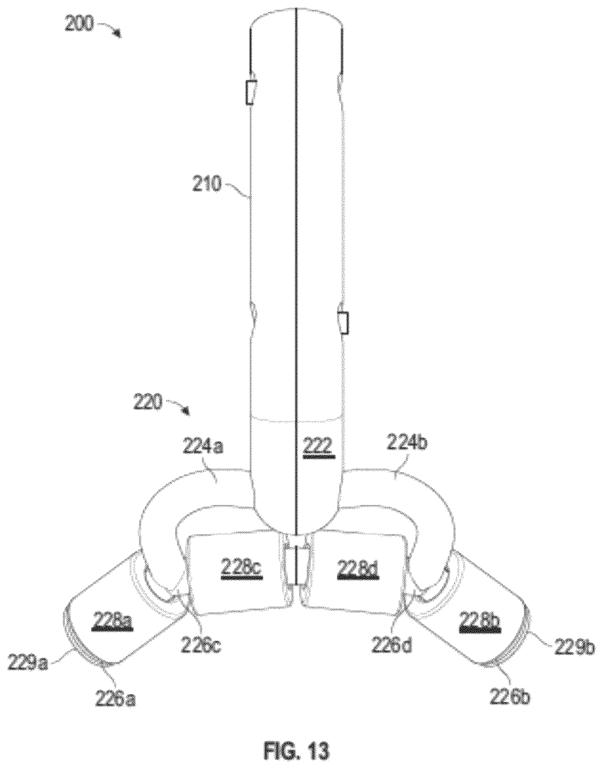

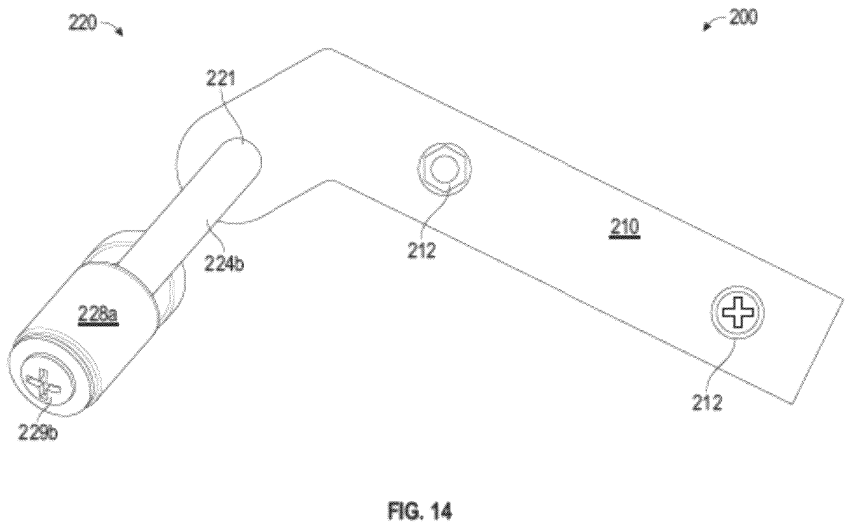

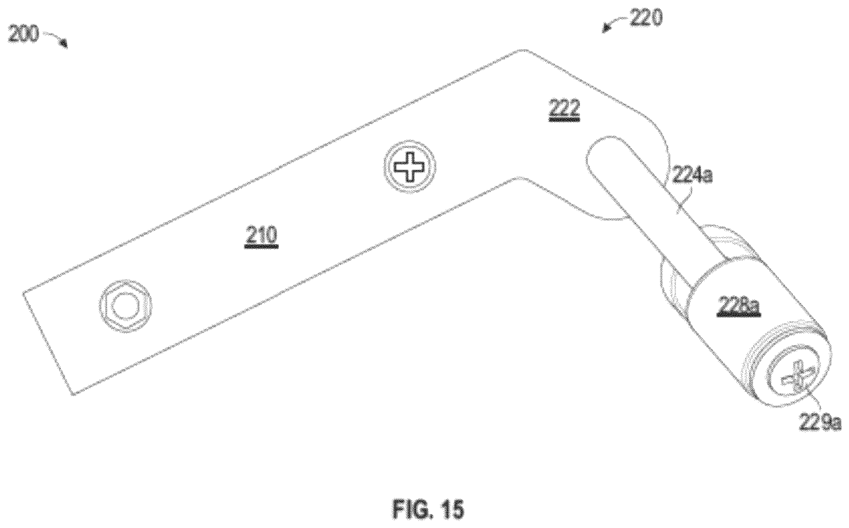

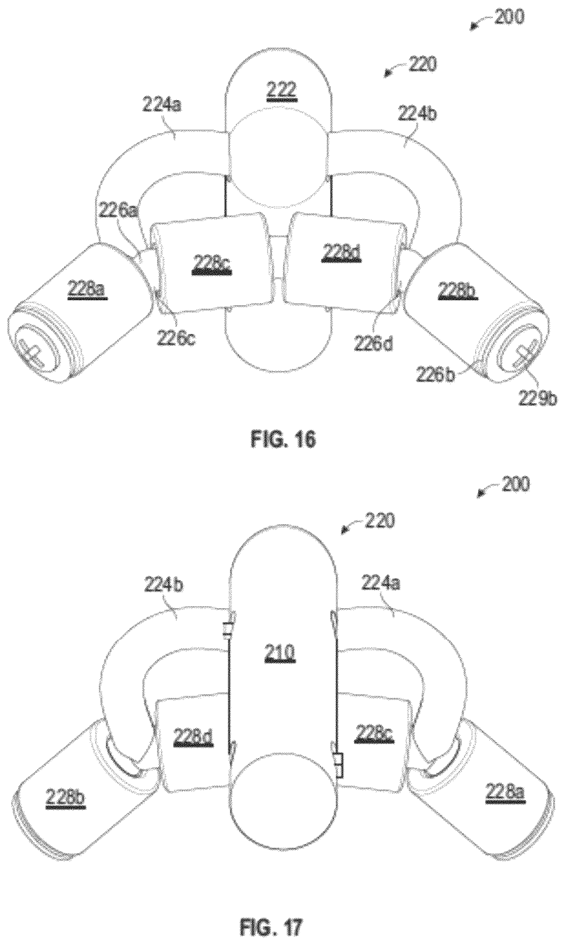

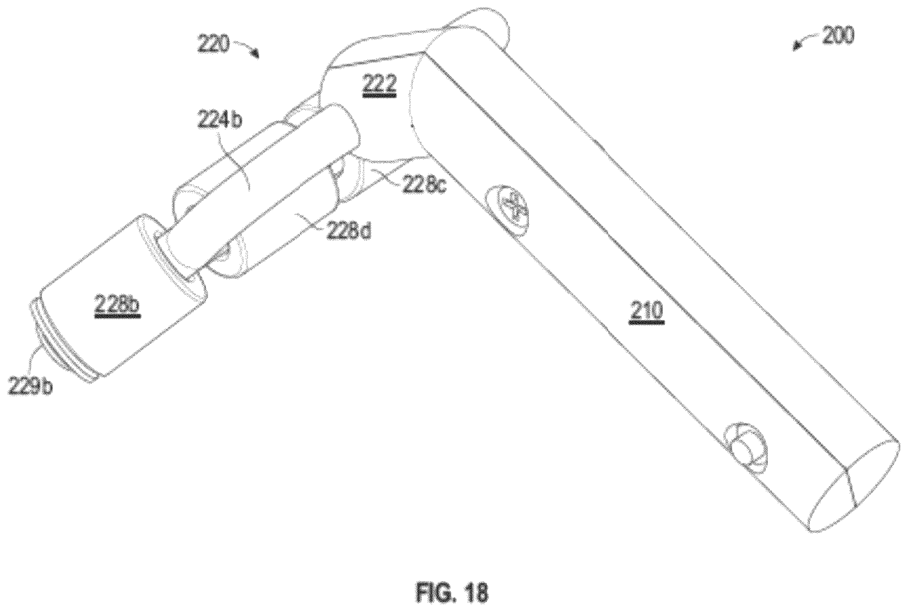

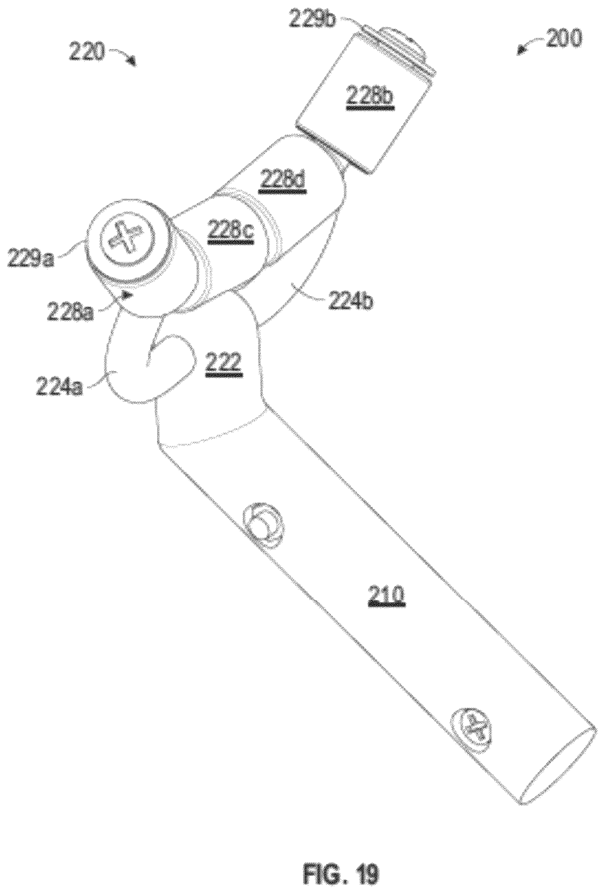

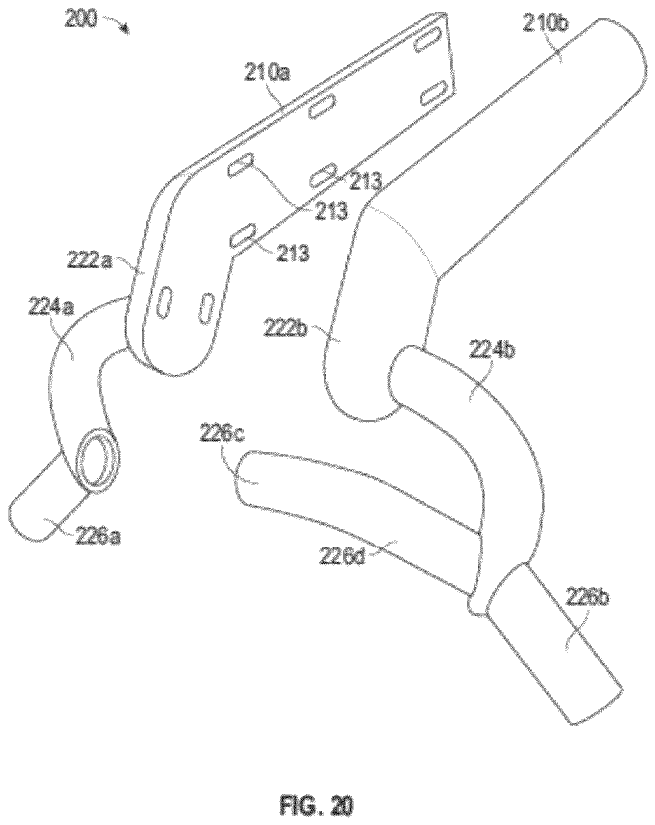

FIG. 12 is a bottom view of another tissue massager 200, according to some example embodiments. In this example, the tissue massage has a roller assembly on one side of a handle rather than both sides as in the embodiment of FIGS. 1-8. FIGS. 13-19 illustrate various other views of tissue massager 200. Tissue massager 200 includes a handle 210 having a first direction of extension toward a first roller assembly 220 coupled to a first end of handle 210. While the present disclosure is not so limited, handle 210 may have a substantially cylindrical form. Further, while the present disclosure is not so limited, in some embodiments, handle 210 may be formed of separate and/or mirroring portions (see, e.g., FIG. 20 and left and right halves molded, printed, forged, carved or formed in any other way). In some such embodiments, see e.g., FIG. 14, such separate and/or mirroring portions may be fixed to one another via one or more fasteners 212, e.g., screw and nut combination or any other suitable type of fastener. Alternatively, in some such embodiments, see e.g., FIG. 20, such separate and/or mirroring portions may be fixed to one another via one or more snap-or clip-type fasteners 213, or any other suitable type of fastener. The two portions may also be fixed together by gluing, melting, or snapping together with integral snapping engagement features.

Similar to the roller assemblies shown and described with reference to FIGS. 1-8, first roller assembly 220 includes a first neck 222 having a second direction of extension and extending from the first end of handle 210 at a first angle with respect to first direction of extension of the handle 210. In some embodiments, the first angle is between 0° and 90°. In some embodiments, first angle 223 is between 45° and 75°. In some embodiments, first angle 223 is substantially 45°.

First roller assembly 220 has a first bracket arm 224a coupled to a first side of first neck 222, and a second bracket arm 224b coupled to a second side of first neck 222 opposite the first side. In some embodiments, first bracket arm 224a and second bracket arm 224b are disposed in a same plane that is, itself, disposed at a second angle with respect to second direction of extension of first neck 222 of first roller assembly 220.

A first roller shaft 226a of first roller assembly 220 extends laterally from a distal end of first bracket arm 224a and a second roller shaft 226c of first roller assembly 220 extends medially from the distal end of first bracket arm 224a. A third roller shaft 226d of the first roller assembly extends medially from a distal end of second bracket arm 224b and a fourth roller shaft 226b of first roller assembly 220 extends laterally from the distal end of second bracket arm 224b.

First roller assembly 220 includes four rollers 228a, 228b, 228c, 228d, each disposed on a respective one of roller shafts 226a-226d. In this example, each roller 228a-228d has a substantially cylindrical form, although different surface shapes, such as concave, may also be utilized. As illustrated in at least FIGS. 10A-10D, each roller shaft 226a-226d, and so each roller 228a-228d, may be disposed at a different angle. The direction of extension of each of roller shafts 226a-226d defines an axis of rotation of each of rollers 228a-228d. Dashed lines (see FIGS. 10A to 10D) illustrate a direction of applied pressure for each of rollers 228a-228d, which is generally normal to the surface of each of rollers 228a-228d.

While the present disclosure is not so limited, as shown in FIGS. 10A, 10B, and 10C, the directions of applied pressure for each of rollers 228a-228d may converge at a single focal point C1 or C2. In some embodiments, such a configuration may allow proper, simultaneous and/or distributed application of massaging forces, by each of rollers 228a-228b, to muscles and/or other tissues of a body part disposed against rollers 228a-228d (e.g., a portion of an arm or a portion of a leg). Accordingly, such a configuration may allow proper, simultaneous and/or distributed application of massaging forces, by each of rollers 228a-228d, to muscles and/or other tissues of a body part.

In some embodiments, second roller shaft 226c and third roller shaft 226d extend to meet one another at a midline of tissue massager 200 that is coplanar with first direction of extension of handle 210. Accordingly, respective directions of extension of second roller shaft 226c and third roller shaft 226d may be offset from one another by a desired angle. In yet other embodiments, second roller shaft 226c and third roller shaft 226d are formed, as a single unit, to extend from one of first and second bracket arms 224a, 224b toward, or substantially to, the other of first and second bracket arms 224a, 224b.

In some embodiments, first bracket arm 224a, second bracket arm 224 b, and the respective directions of extension (e.g., dashed lines in FIGS. 10A-10D of each of roller shafts 226a-226d are disposed in the same plane.

### Example Tissue Massager 300

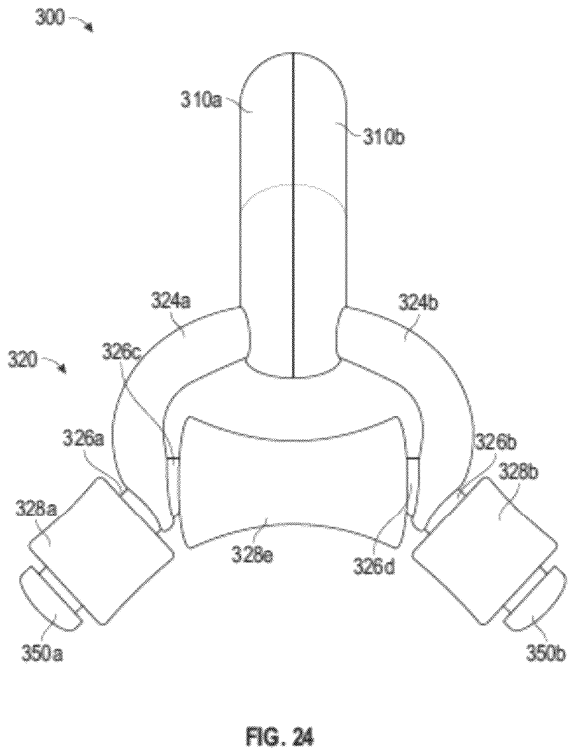

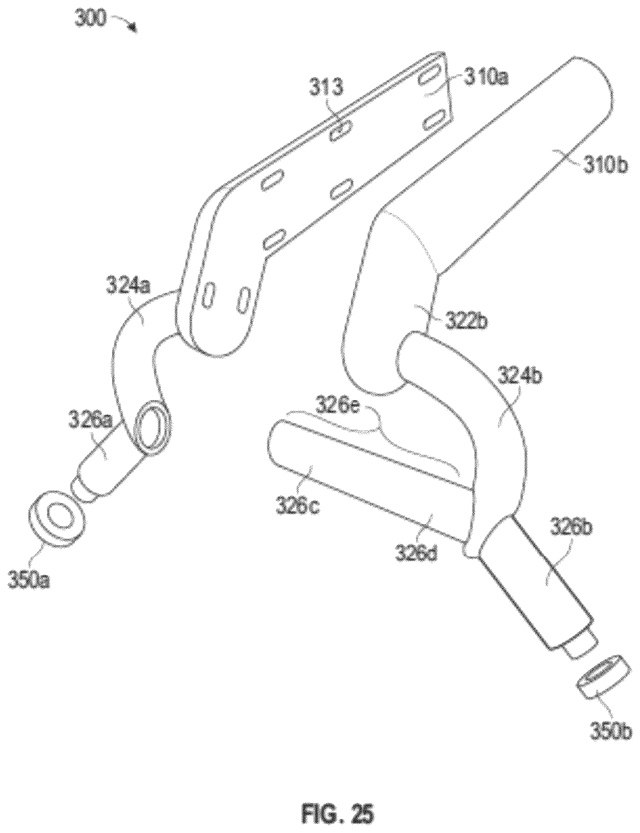

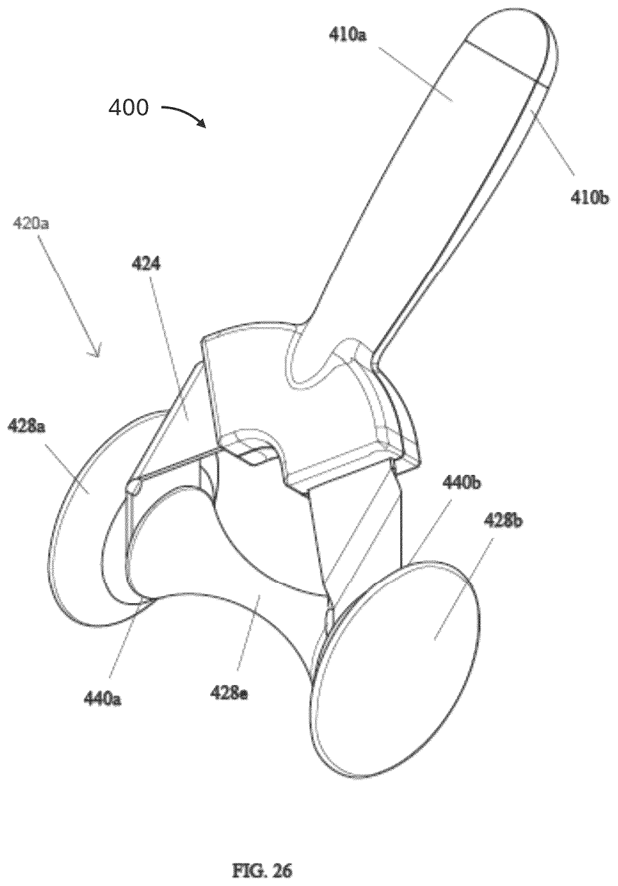

FIG. 23 is a top perspective view of another tissue massager 300, according to some example embodiments. FIGS. 24 and 25 illustrate other views of tissue massager 300. Tissue massager 300 includes a handle 310 and a first roller assembly 320 coupled to a first end of handle 310. While the present disclosure is not so limited, handle 310 may have a substantially cylindrical form. Further, while the present disclosure is not so limited, in some embodiments, handle 310 may be formed of separate and/or mirroring portions (see, e.g., FIG. 25 and left and right halves molded, printed, forged, carved or formed in any other way). In some such embodiments, separate and/or mirroring portions may be fixed to one another via one or more fasteners, e.g., screw and nut combination or any other suitable type of fastener. Alternatively, in some such embodiments, see e.g., FIG. 25, such separate and/or mirroring portions may be fixed to one another via one or more snap-or clip-type fasteners 313, or any other suitable type of fastener. The two portions may also be fixed together by glueing, melting or snapping together.

First roller assembly 320 includes a first neck 322 having a second direction of extension and extending from the first end of handle 310.

First roller assembly 320 has a first bracket arm 324a coupled to a first side of first neck 322, and a second bracket arm 324b coupled to a second side of first neck 322 opposite the first side. In some embodiments, first bracket arm 324a and second bracket arm 324b are disposed in a same plane.

A first roller shaft 326a of first roller assembly 320 extends laterally from a distal end of first bracket arm 324a and a second roller shaft 326c of first roller assembly 320 extends medially from the distal end of first bracket arm 324a. A third roller shaft 326d of the first roller assembly extends medially from a distal end of second bracket arm 324b and a fourth roller shaft 326b of first roller assembly 320 extends laterally from the distal end of second bracket arm 324b.

First roller assembly 320 includes three rollers 328a, 328e, 328b. Each roller 328a, 328e, 328b, has a substantially cylindrical form. As illustrated in at least FIG. 23-24, each roller 328a, 328e, 328c, are disposed at a different angles. In some embodiments, roller 328a, 328e, 328b may be substantially concave rollers.

In some embodiments, second roller shaft 326c and third roller shaft 326d extend to meet one another at a midline of tissue massager 300. Accordingly, respective directions of extension of second roller shaft 326c and third roller shaft 326d may be offset from one another by a desired angle. In yet other embodiments, second roller shaft 326c and third roller shaft 326d are formed, as a single unit, to extend from one of first and second bracket arms 324a, 324b toward, or substantially to, the other of first and second bracket arms 324a, 324b (see, e.g., FIG. 25). In some embodiments, tissue massager will have caps 350a and 350b that will hold rollers 328a and 328b in place respectively. The caps can be fixed to the shafts 326a and 326b respectively by snapping, glueing, melting or any other suitable method.

In some embodiments, tissue massager 300 may include two roller assemblies, one assembly on each side of handle 310, as described in tissue massager 100.

### Example Tissue Massager 400

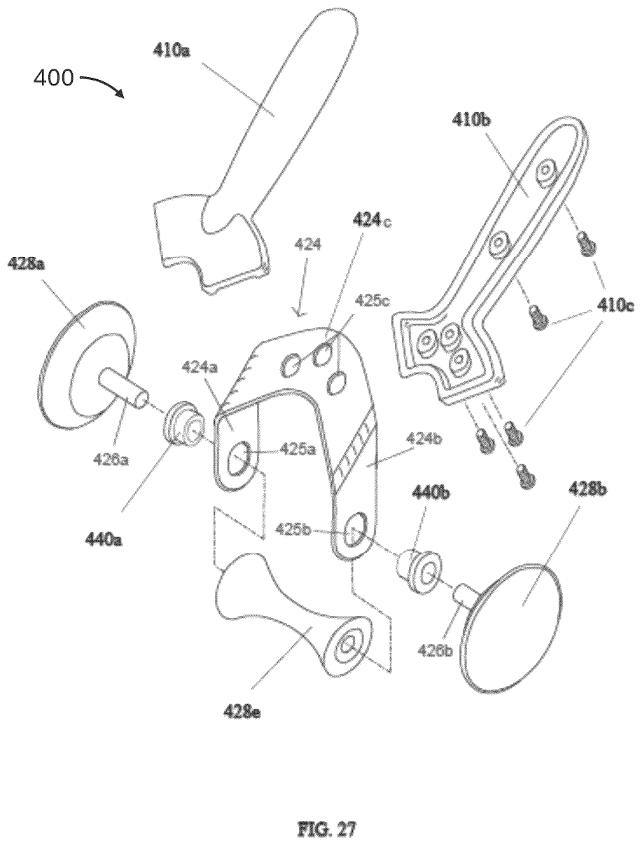

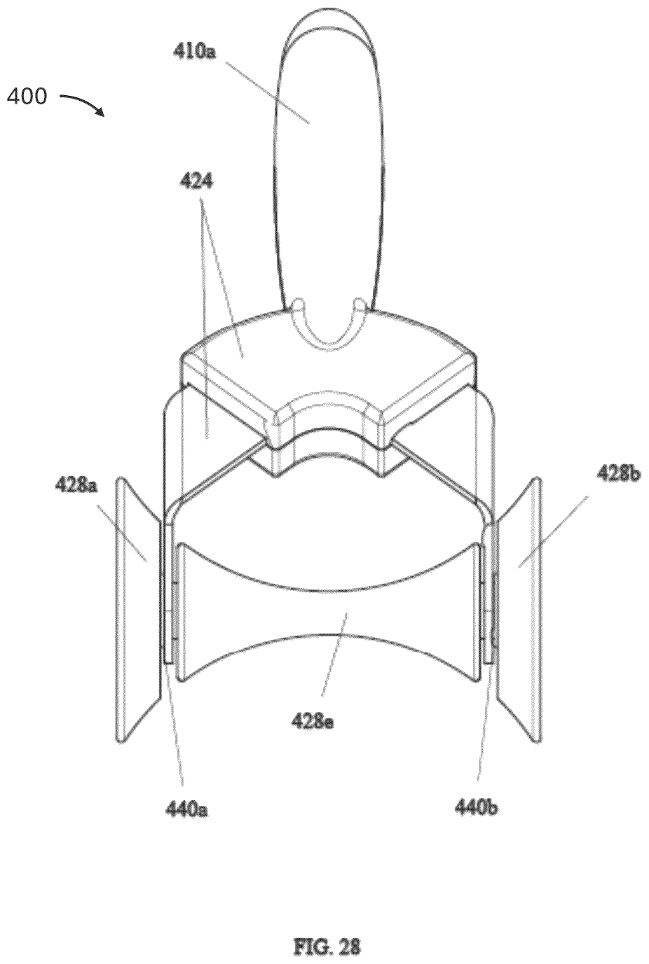

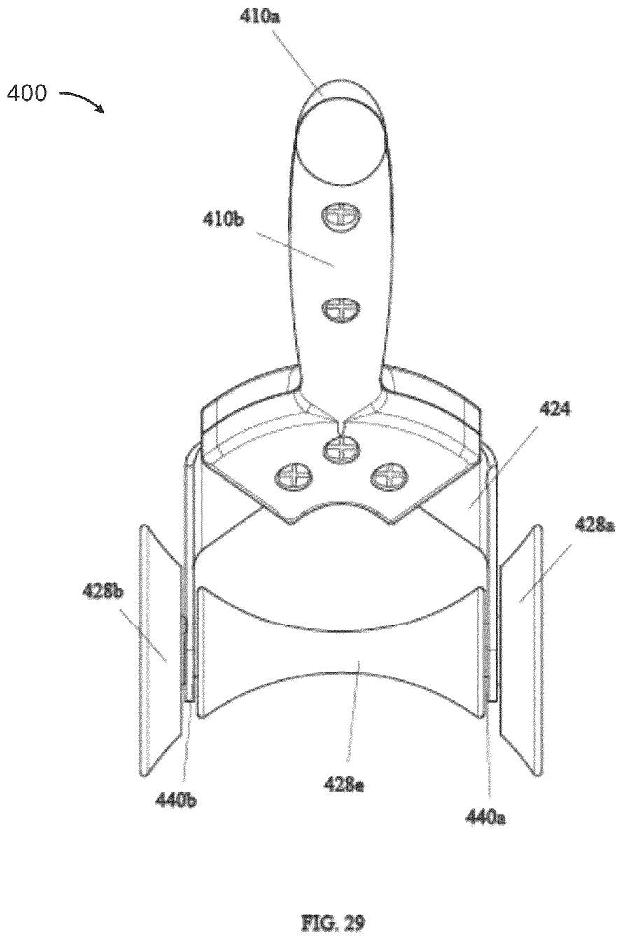

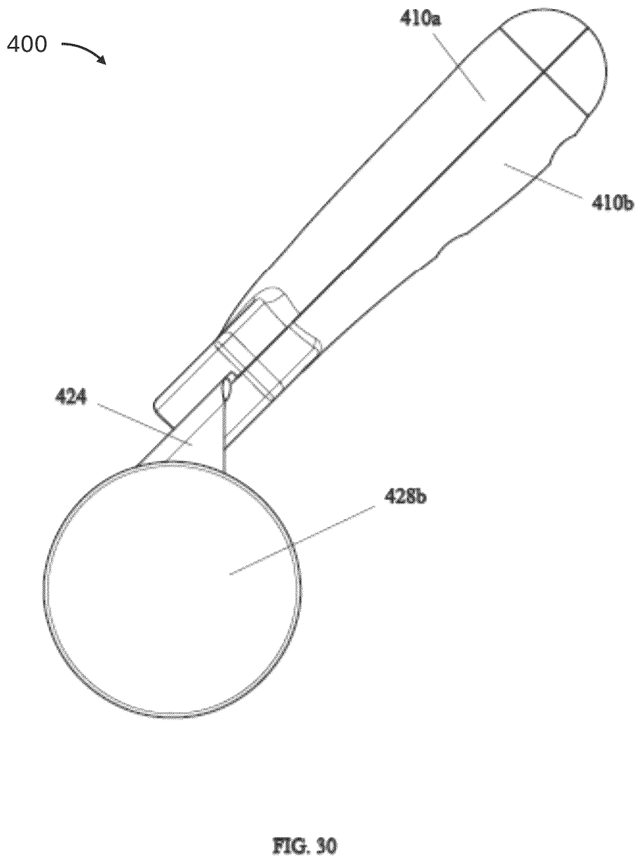

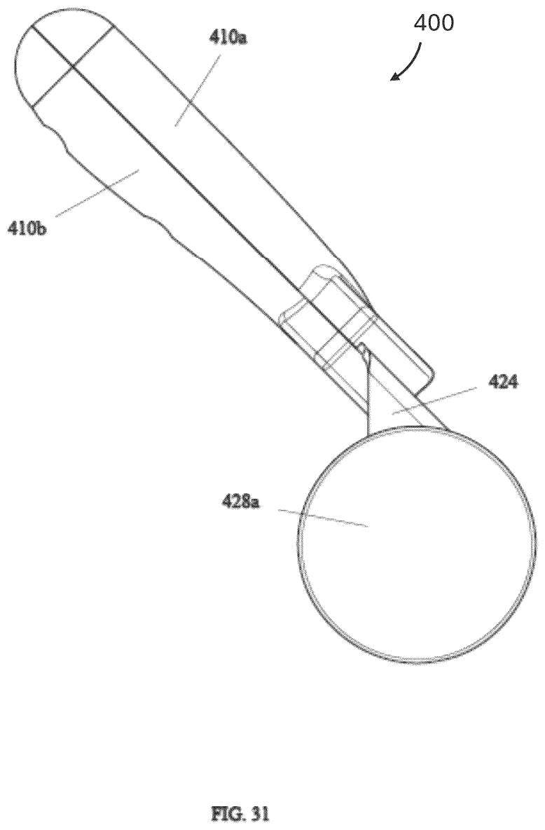

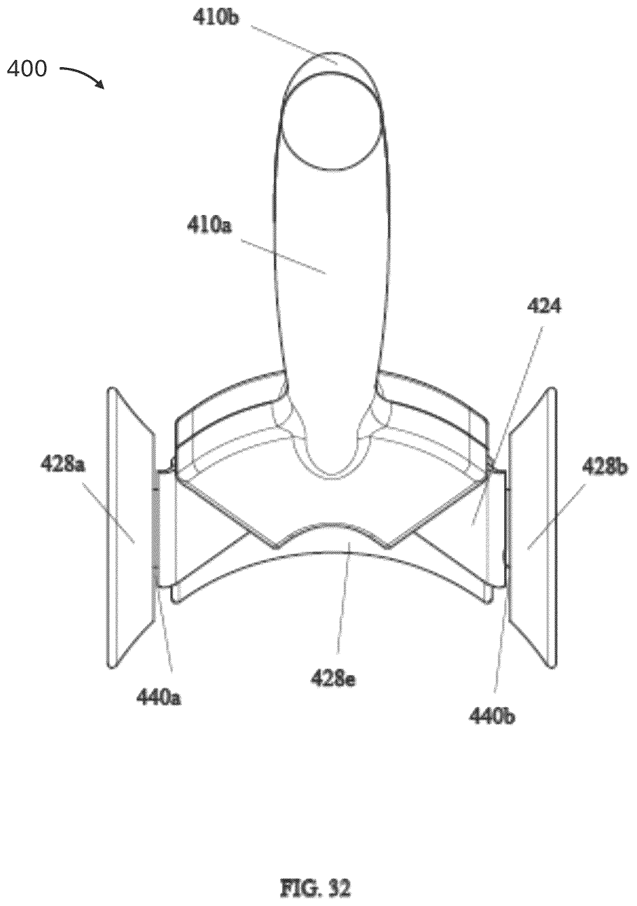

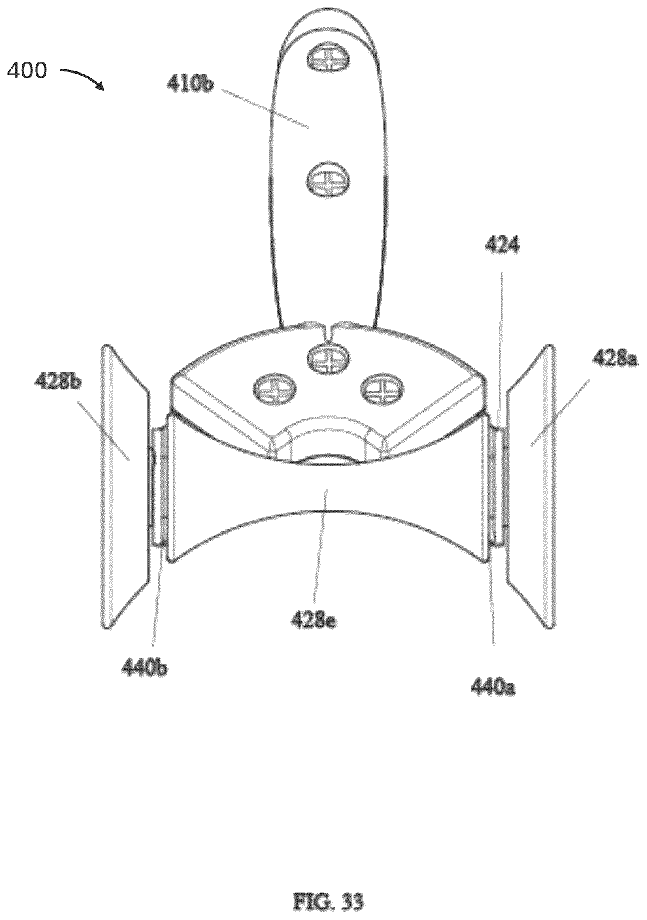

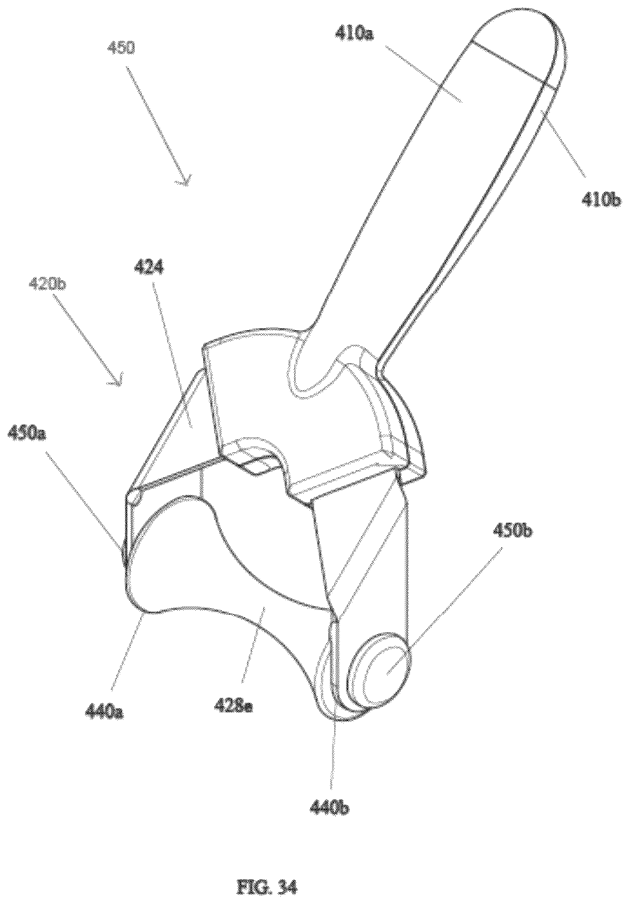

FIGS. 26-33 illustrate different views of yet another tissue massager 400, according to some example embodiments. For example, FIG. 26 illustrates a perspective view of a tissue massager 400, according to some example embodiments; FIG. 27 illustrates an exploded perspective view of tissue massager 400. FIG. 28 illustrates a front view of tissue massager 400; FIG. 29 illustrates a back view of tissue massager 400; FIG. 30 illustrates a left side view of tissue massager 400; FIG. 31 illustrates a right side view of tissue massager 400, opposite the view of FIG. 30; FIG. 32 illustrates a top view of tissue massager 400; FIG. 33 illustrates a bottom view of tissue massager 400, opposite the view of FIG. 32.

Tissue massager 400 includes a handle 410 and a first roller assembly 420 coupled to a first end or portion of handle 410. In some embodiments, this first end or portion of handle 410 may also be considered a distal end or portion of handle 410. Handle 410 also comprises a second end or portion, opposite the first end or portion. In some embodiments, the second end or portion of handle 410 may also be considered a proximal end or portion of handle 410. In some embodiments, the first end or portion of handle 410 has a semi-circular form factor, for example, having a form factor of approximately one quarter of a ring or doughnut. In some embodiments, this first end or portion of handle 410 has substantially flat and/or planar outward-facing surfaces. This first end or portion of handle 410 is configured to house, or have disposed at least partly therein and/or therethrough, a portion of a roller bracket 424. In some embodiments, the second end or portion of handle 410 has an oblong shape that is rounded to generally provide a surface around which a user grasps tissue massager with a hand.

While the present disclosure is not so limited, in some embodiments, handle 410 may be formed of separate and/or mirroring sides 410a, 410b (see, e.g., FIG. 27 and top and bottom halves molded, printed, forged, carved or formed in any other way). In some such embodiments, such separate and/or mirroring side 410a, 410b may be fixed to one another via one or more fasteners, e.g., combination of screw and threaded aperture or any other suitable type of fastener. Accordingly, in such embodiments, a first one of sides 410a, 410b comprises a plurality of apertures configured to receive a screw therethrough and the second of sides 410a, 410b comprises a plurality of threaded apertures, each configured to threadingly receive one of the screws disposed through a respective one of the plurality of apertures of the first of portions 410a, 410b. In some such embodiments, at least one of the plurality of apertures of the first of sides 410a, 410b is disposed in the first end or portion of that side and at least one of the plurality of apertures of the first of sides 410a, 410b is disposed in the second end or portion of that side. Similarly, at least one of the plurality of threaded apertures of the second of sides 410a, 410b is disposed in the first end or portion of that side and at least one of the plurality of threaded apertures of the second of sides 410a, 410b is disposed in the second end or portion of that side. Accordingly, at least one of fasteners 410c is configured to secure mirroring first portions of sides 410a, 410b together and at least one other of fasteners 410c is configured to secure mirroring second portions of sides 410a, 410b together. Alternatively, such separate and/or mirroring sides 410a, 410b may be fixed to one another via one or more snap-or clip-type fasteners (see, e.g., fasteners 213 of tissue massager 200 in FIG. 20 or fasteners 313 of tissue massager 300 in FIG. 25), or any other suitable type of fastener. The two portions may also be fixed together by glueing, melting or snapping together.

First roller assembly 420 comprises a roller bracket 424 configured to be secured within and/or through the first portion or end of handle 410. For example, roller bracket 424 may comprise a central portion 424c having at least one aperture (e.g., a plurality of apertures are illustrated in FIG. 27). One of screws 410c may be configured to extend through an aperture in the first end or portion of the first side 410b of handle, through an aperture 425c in central portion 424c of roller bracket 424 and then through or into a threaded aperture in the first end or portion of the second side 410a of handle. In this way, central portion 424c of roller bracket 424 is sandwiched and secured between sides 410a, 410b of handle 410, which are fastened to one another via fasteners 410c.

First roller assembly 420 has a first bracket arm 424a extending from a first side of central portion 424c of roller bracket 424, and a second bracket arm 424b extending from a second side of central portion 424c of roller bracket 424. In some embodiments, first bracket arm 424a, second bracket arm 424 b and central portion 424 c are formed of a single piece, for example, comprising metal and/or plastic, that is bent at the first and second sides of central portion 424c to form first and second bracket arms 424a, 424b. In some such embodiments, first bracket arm 424a and second bracket arm 424b extend substantially parallel to one another.

First roller assembly 420 further includes three rollers 428a, 428e, 428b. Each roller 428a, 428e, 428b, has a substantially concave cylindrical form such that, together, the directions of applied pressure for each of rollers 428a, 428e, 428b (e.g., lines extending normal, or at right angles, to the concave surface of rollers 428a, 428e, 428b) may converge at a single focal point. In some embodiments, such a configuration may allow proper, simultaneous and/or distributed application of massaging forces, by each of rollers 428a, 428e, 428b, to muscles and/or other tissues of a body part disposed against rollers 428a, 428e, 428b (e.g., a portion of an arm or a portion of a leg).

For example, roller 428a may have a larger diameter at an outermost side than at an innermost side. Similarly, roller 428b may have a larger diameter at an outermost side than at an innermost side. And roller 428e may have a larger diameter at its outermost sides than at its center. Accordingly, the concave surfaces of rollers 428a, 428e, 428b may each extend along adjacent portions of a contiguous curving path formed in roller assembly 420. Similar to the configurations shown in FIGS. 10A through 10D, the contiguous path may be circular with a single radius of curvature or may have different curvature profiles along different portions of the overall concave profile.

As shown in the exploded view of FIG. 27, in some embodiments, roller 428a comprises a first roller shaft 426a extending laterally away from an inside surface of roller 428a. Shaft 426a is configured to extend through a bushing 440a. At least a portion of shaft 426a and at least a portion of bushing 440a are configured to extend through an aperture 425a in first bracket arm 424a. And at least an end of shaft 426a is configured to extend into an axial aperture of roller 428e. In some embodiments, an end of bushing 440a, beyond which the end of shaft 426a extends, may also be configured to extend into the axial aperture of roller 428e. Similarly, roller 428b comprises a second roller shaft 426b extending laterally away from an inside surface of roller 428b. Shaft 426b is configured to extend through a bushing 440b. At least a portion of shaft 426b and at least a portion of bushing 440b are configured to extend through an aperture 425b in second bracket arm 424b. And at least an end of shaft 426b is configured to extend into an axial aperture of roller 428e. In some embodiments, this axial aperture is simply the continuation of the axial aperture in the other side of roller 428e. Alternatively, separate axial apertures may be disposed in each side of roller 428e. In some embodiments, an end of bushing 440b, beyond which the end of shaft 426b extends, may also be configured to extend into this axial aperture of roller 428e. In yet other embodiments, rather than two shafts 426a, 426b extending from respective rollers 428a, 428b, a single shaft may extend between rollers 428a and 428b, through roller 428e.

### Example Tissue Massager 450

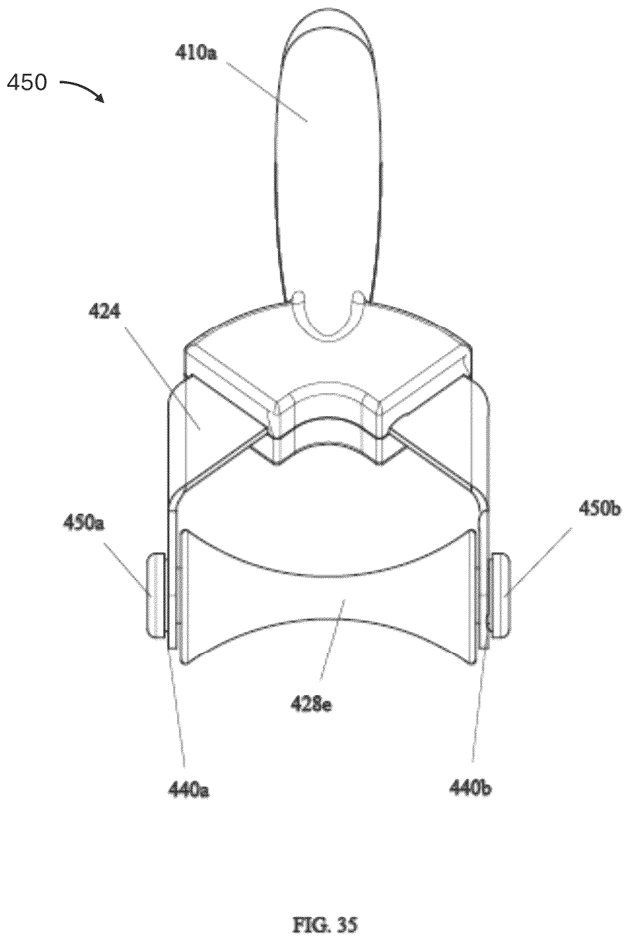

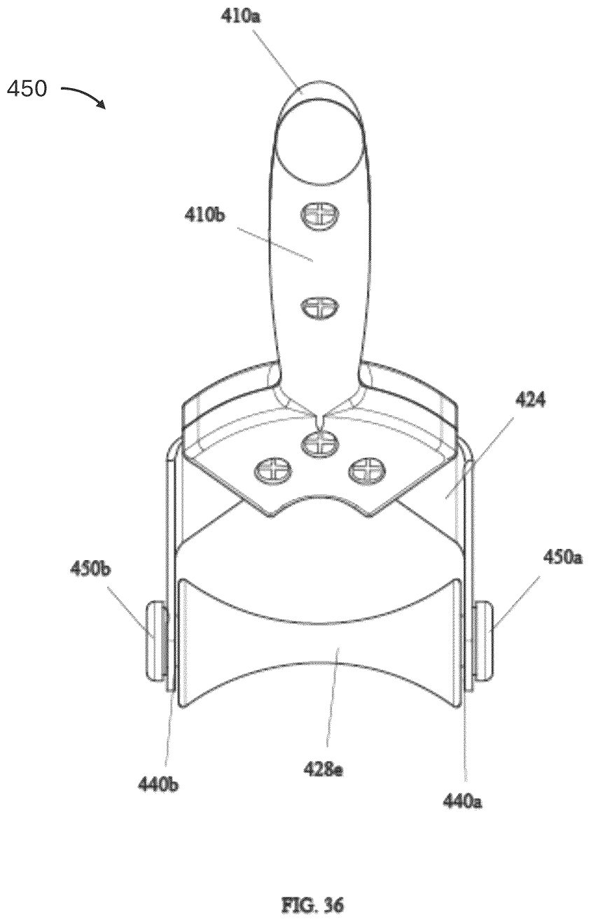

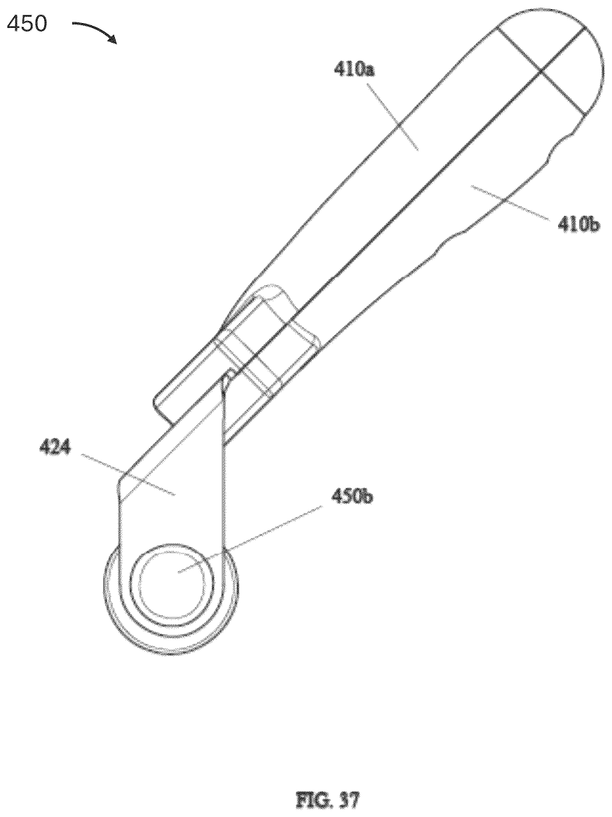

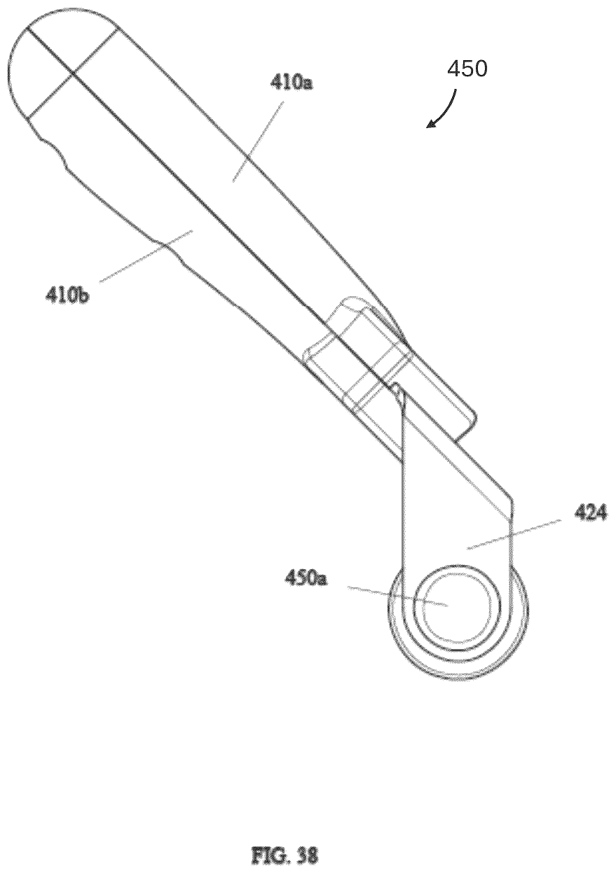

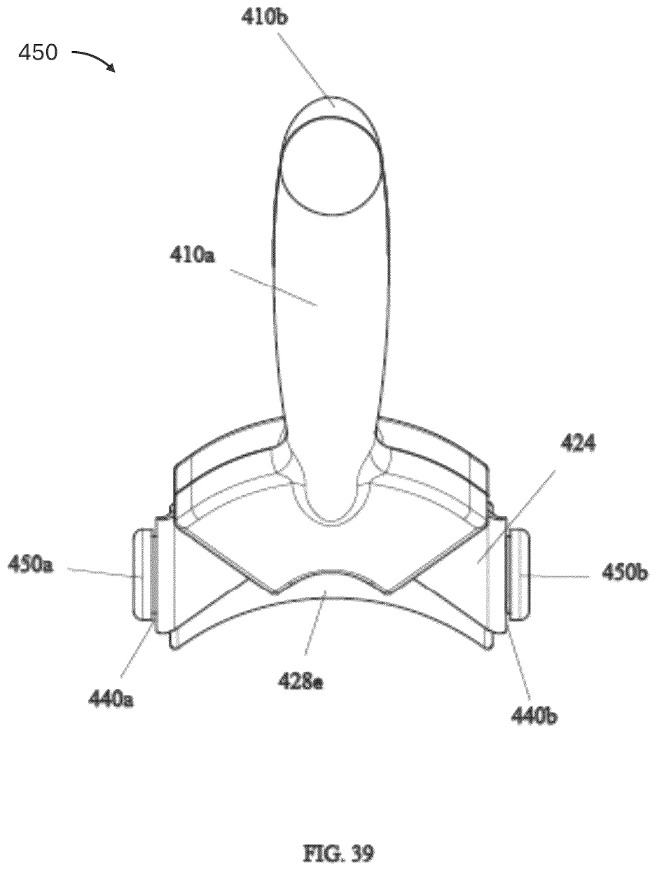

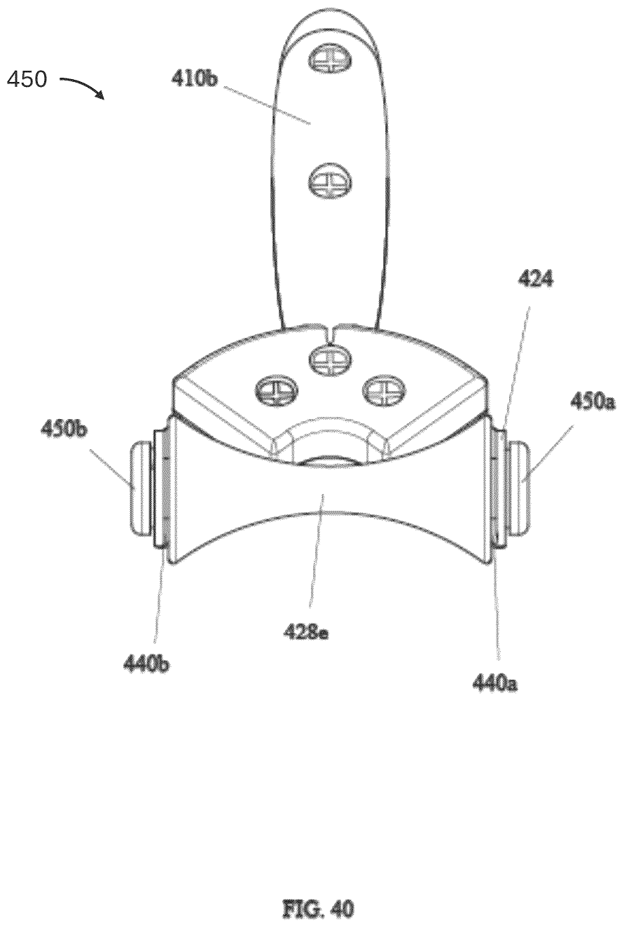

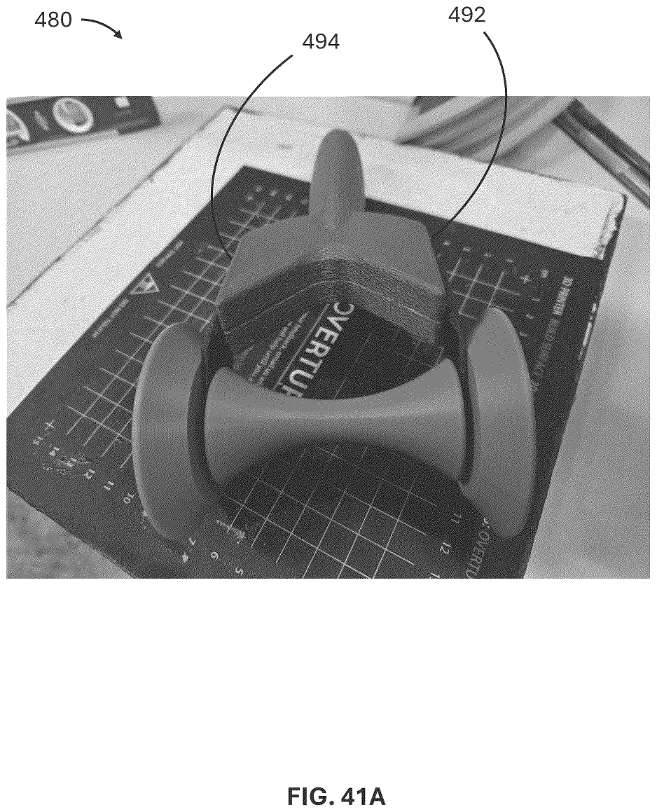

FIGS. 34-40 illustrate different views of yet another tissue massager 450, according to some example embodiments. For example, FIG. 34 illustrates a perspective view of a tissue massager 450, according to some example embodiments; FIG. 35 illustrates a front view of tissue massager 450; FIG. 36 illustrates a back view of tissue massager 450; FIG. 37 illustrates a left side view of tissue massager 450; FIG. 38 illustrates a right side view of tissue massager 450, opposite the view of FIG. 37; FIG. 39 illustrates a top view of tissue massager 450; FIG. 40 illustrates a bottom view of tissue massager 450, opposite the view of FIG. 39.

Tissue massager 450 is substantially identical to tissue massager 400, except that it utilizes a second roller assembly 420b employing roller bracket 420 and roller 428e, as previously described, but omitting rollers 428a, 428b and, instead, utilizing caps 450a, 450b, as described below.

Caps 450a and 450b may each have a smaller diameter than an outermost side of roller 428e. Accordingly, caps 450a, 450b are not configured to contact the user's tissue and, therefore, are not configured as rollers. While not visible in FIGS. 34-40, similar, or otherwise identical to that shown in the exploded view of FIG. 27, in some embodiments, cap 450a comprises a first roller shaft 426a extending laterally away from an inside surface of cap 450a. Shaft 426a is configured to extend through bushing 440a. At least a portion of shaft 426a and at least a portion of bushing 440a are configured to extend through aperture 425a in first bracket arm 424a. And at least an end of shaft 426a is configured to extend into the axial aperture of roller 428e. In some embodiments, an end of bushing 440a, beyond which the end of shaft 426a extends, may also be configured to extend into the axial aperture of roller 428e. Similarly, cap 450b comprises a second roller shaft 426b extending laterally away from an inside surface of cap 450b. Shaft 426b is configured to extend through bushing 440b. At least a portion of shaft 426b and at least a portion of bushing 440b are configured to extend through aperture 425b in second bracket arm 424b. And at least an end of shaft 426b is configured to extend into the axial aperture of roller 428e. As noted above with respect to massager 400, in some embodiments, this axial aperture is simply the continuation of the axial aperture in the other side of roller 428e. Alternatively, separate axial apertures may be disposed in each side of roller 428e. In some embodiments, the end of bushing 440b, beyond which the end of shaft 426b extends, may also be configured to extend into this axial aperture of roller 428e. Caps 450a, 450b can be fixed to shafts 426a and 426b respectively by snapping, glueing, melting or any other suitable method. In yet other embodiments, rather than two shafts 426a, 426b extending from respective caps 450a, 450b, a single shaft may extend between caps 450a, 450b, through roller 428e.

### Example Tissue Massager 480

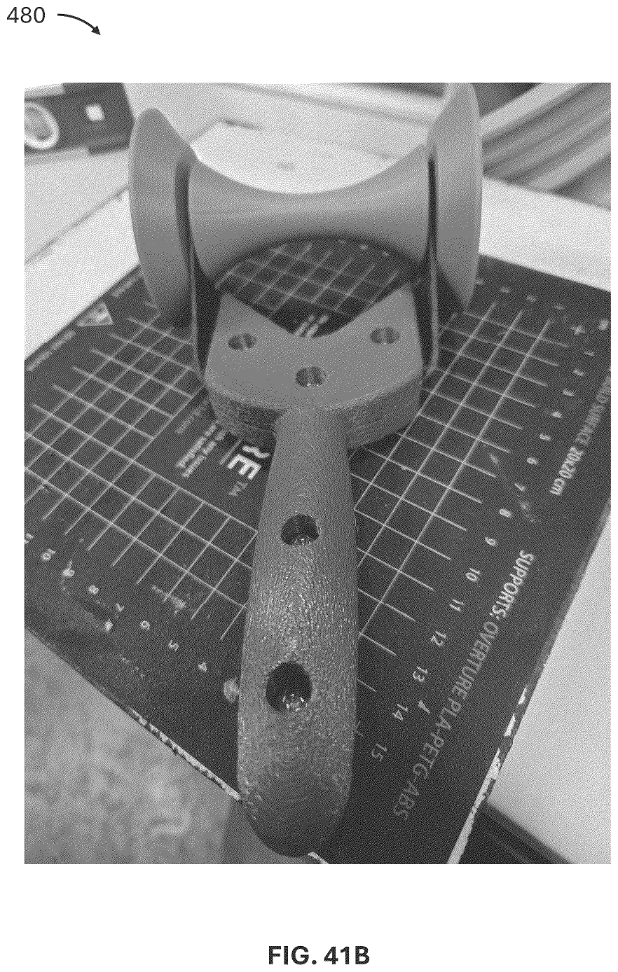

FIGS. 41A and 41B illustrate another embodiment of a tissue massager 480. In this embodiment, the outer sides 492, 494 of the handle portion 410 extend straight along the corner of the bracket 424 instead of extending inward in a wedge shape as shown in FIGS. 26-40 for example. The embodiment of FIGS. 41A and 41B may in all other respects be the same as that shown in FIGS. 26-40.

### Additional Illustrations

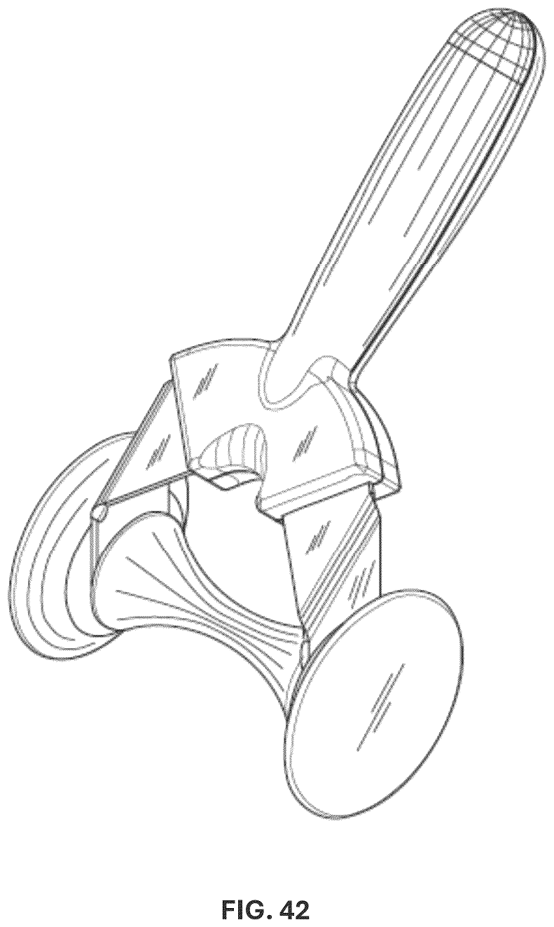

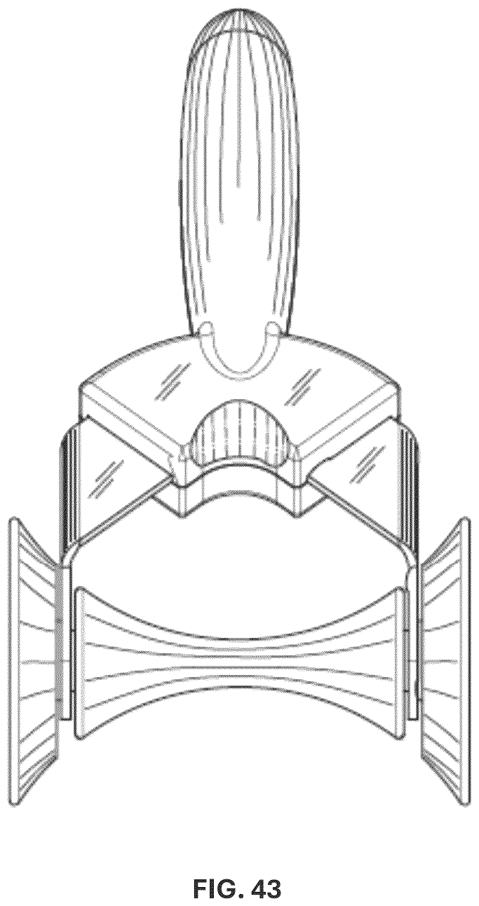

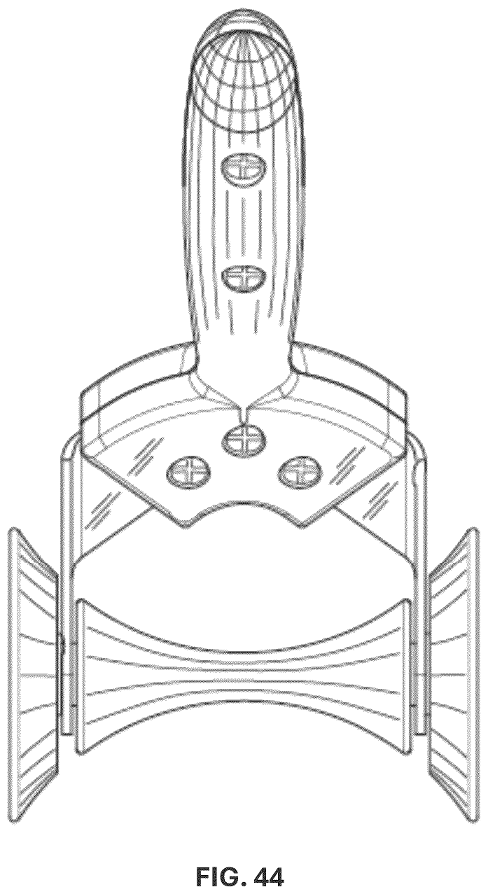

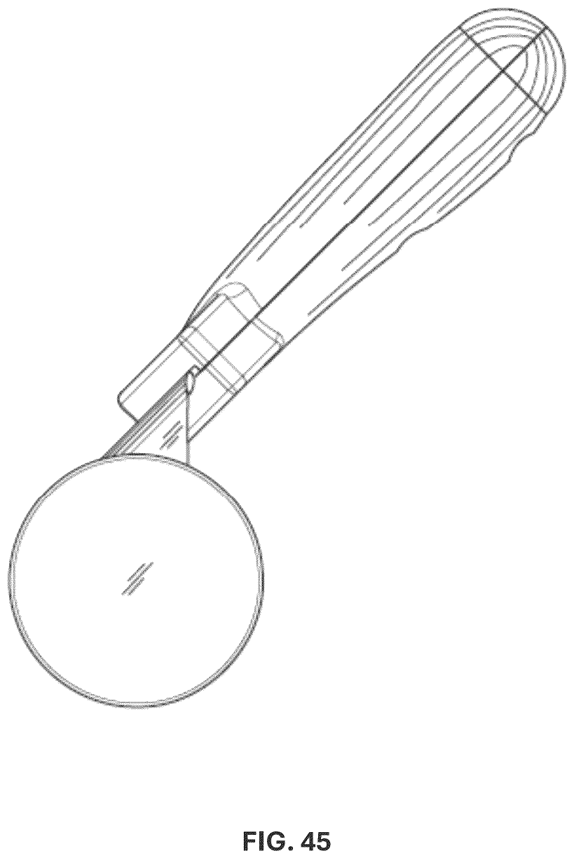

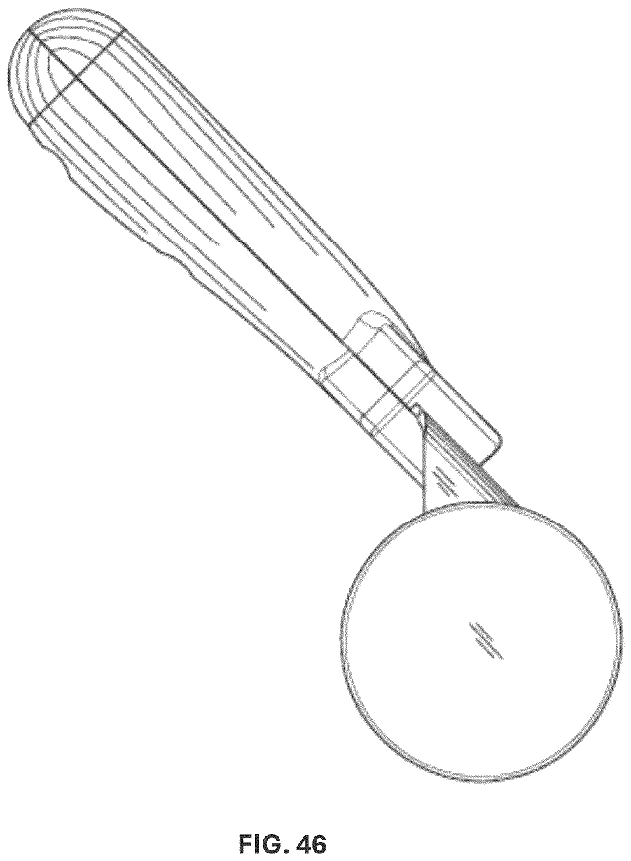

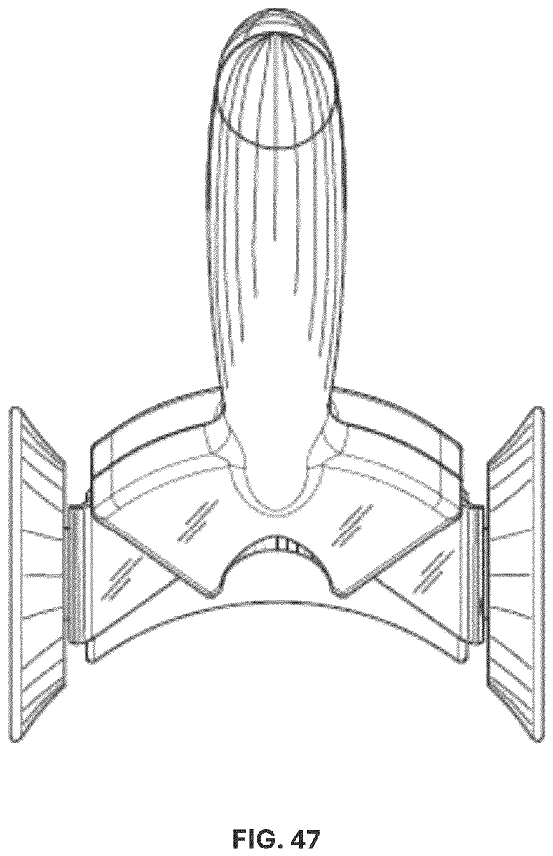

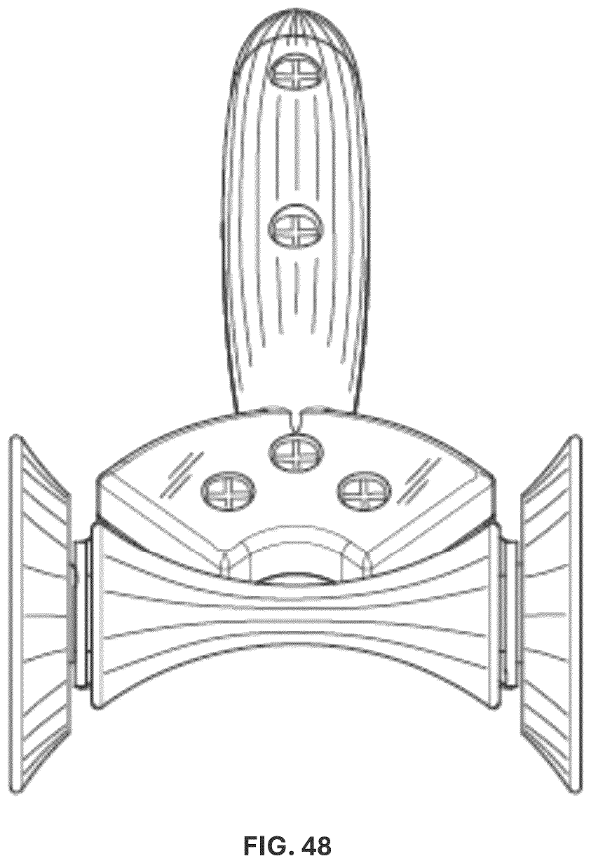

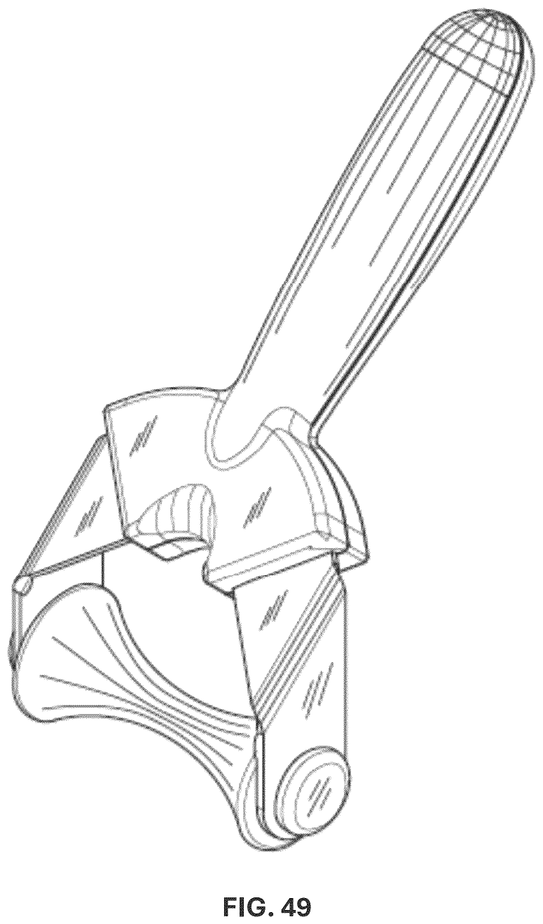

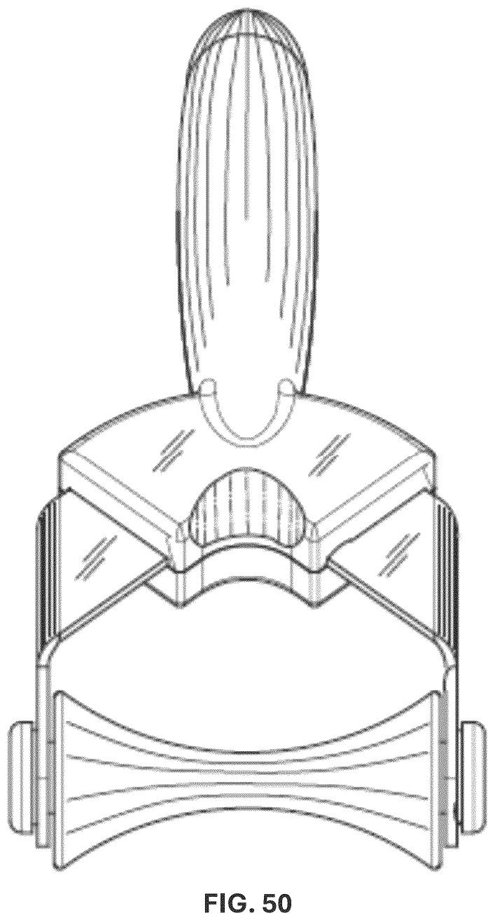

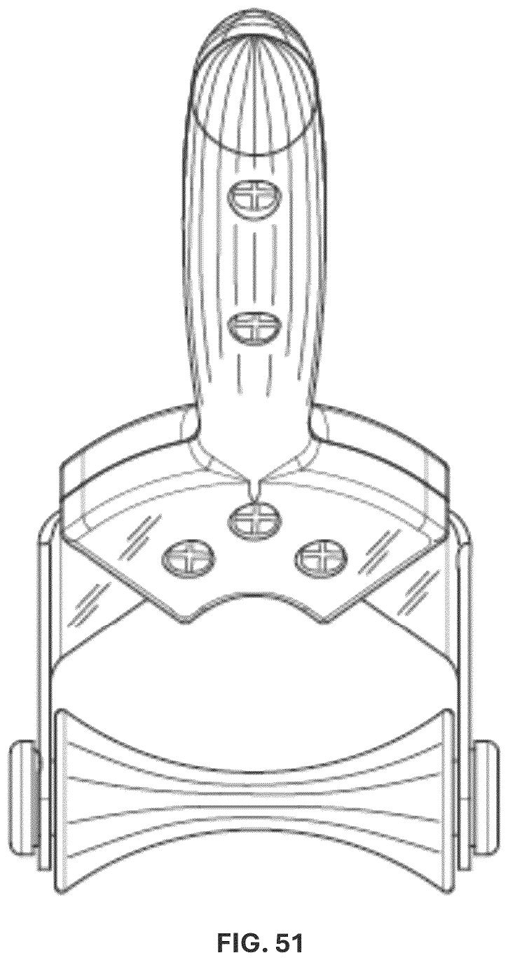

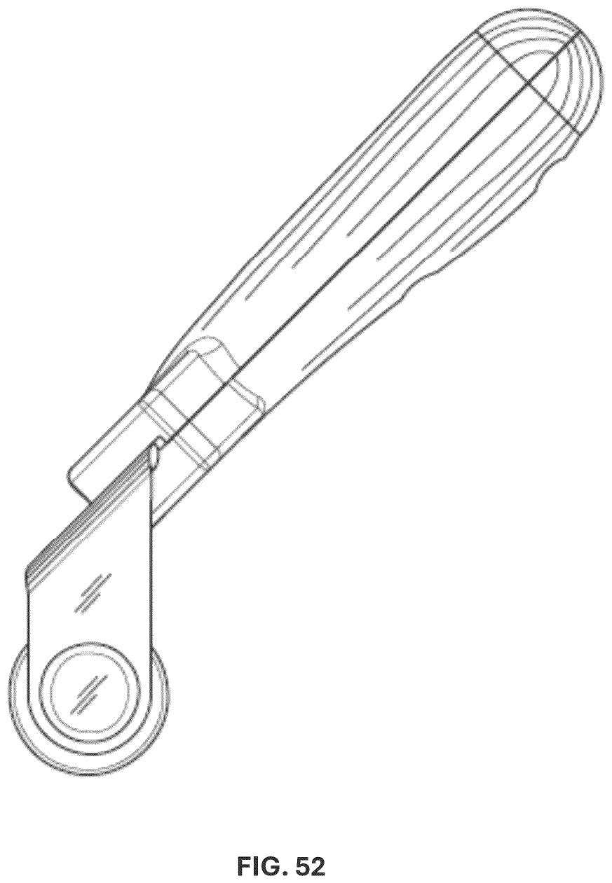

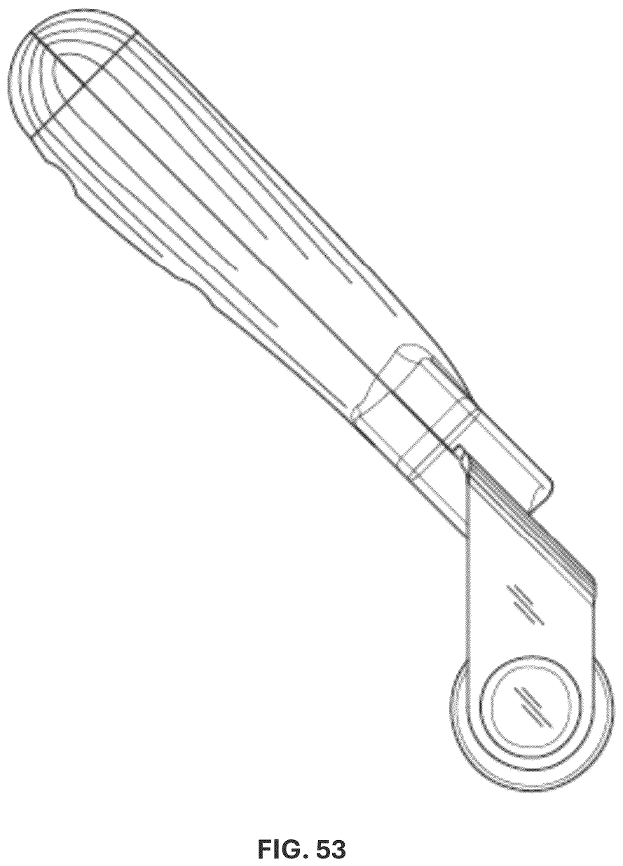

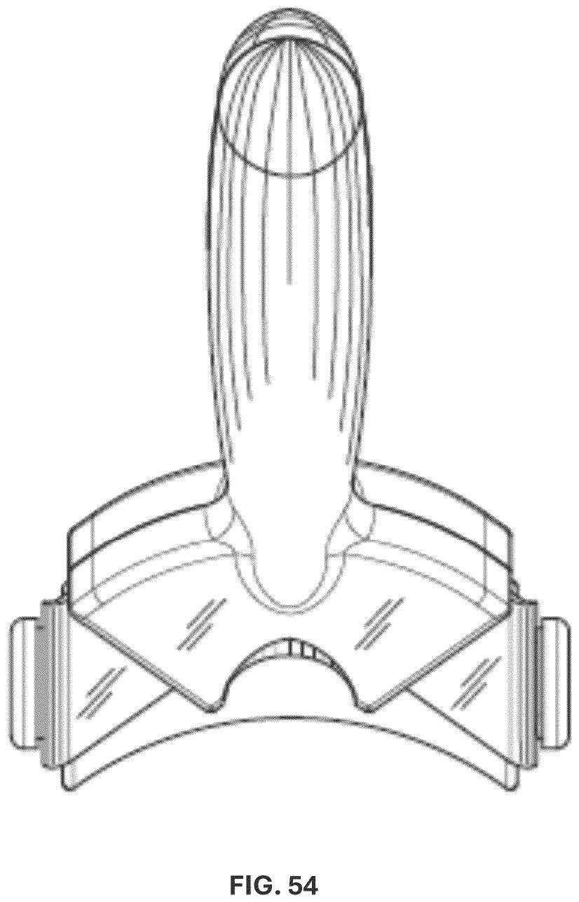

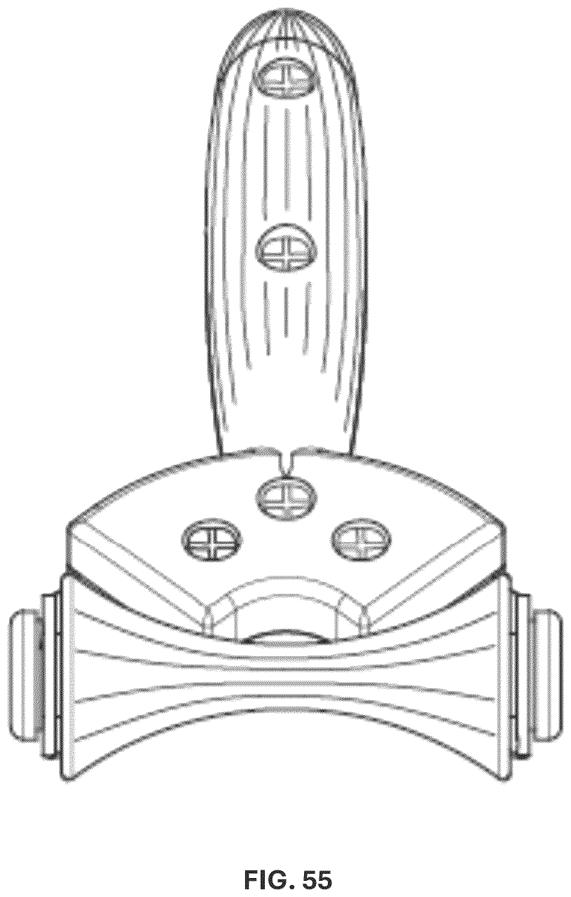

FIGS. 42 through 48 show additional views of the tissue massager embodiment 400, and FIGS. 49 through 55 show additional views of the tissue massager embodiment 450.

### Example Method(s) of Use of A Tissue Massager 100, 200, 300, 400, 450

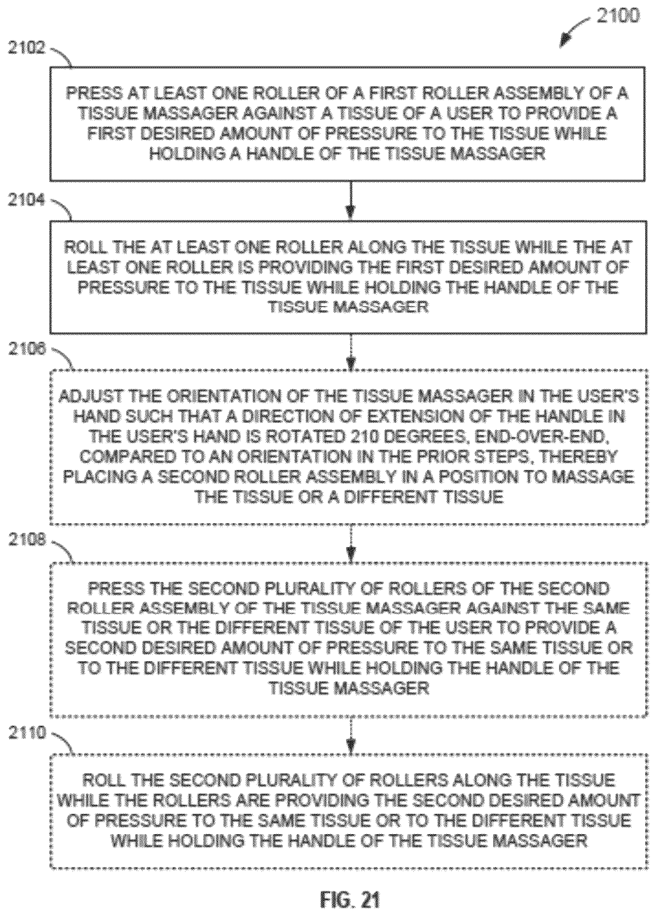

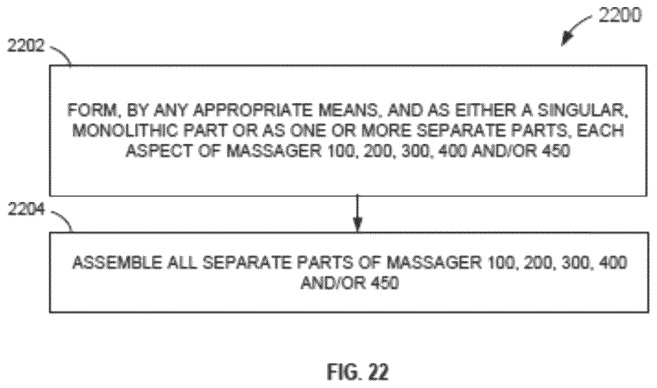

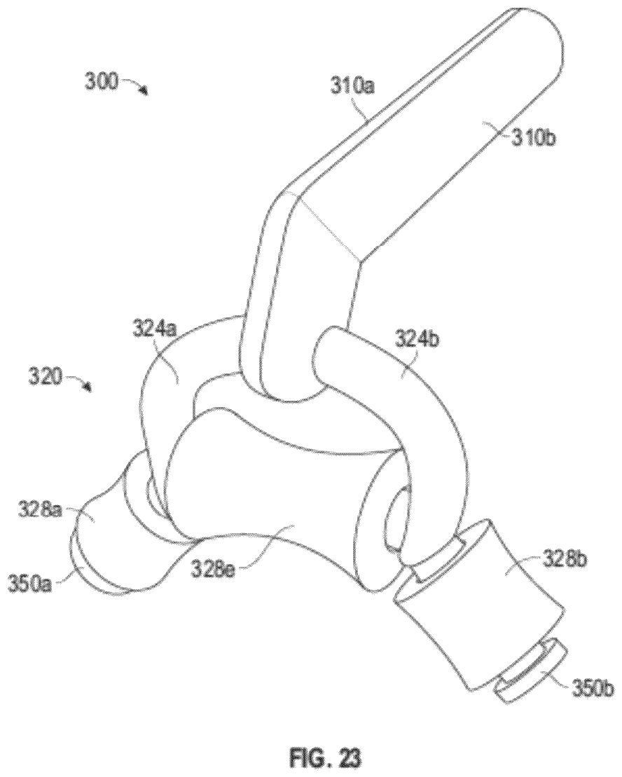

The disclosure now turns to FIG. 21, which illustrates a flowchart 2100 related to a method of utilizing a tissue massager, as described anywhere in this disclosure. Although particular steps are described herein, the present application is not so limited and alternative methods may include a subset of these steps, in the same or different order, combined or mixed in any order, and may include one or more addition steps not described herein or below. Moreover, while one or more aspects of an embodiment may be described as carrying out a step, the present disclosure is not so limited and any portion of a step, any step or any grouping of steps are also contemplated to be carried out by a different aspect of an embodiment, or such portions, steps or grouping of steps may be combined in a way such that they are no longer separate steps.

Step 2102 includes, pressing at least one roller of a first roller assembly of a tissue massager against a tissue of a user to provide a first desired amount of pressure to the tissue while holding a handle of the tissue massager. This tissue massager is any tissue massager explicitly described, or implicitly intimated, by this disclosure.

For example, and not limitation, as previously described in connection with any of FIGS. 1-11B, a user may press rollers 128a-128d of roller assembly 120 of tissue massager 100 against a tissue of the user to provide a first desired amount of pressure to the tissue while holding handle 110 of tissue massager 100.

Alternatively, as also previously described in connection with any of FIGS. 1-11B, a user may press rollers 138a-138b of roller assembly 130 of tissue massager 100 against a tissue of the user to provide the first desired amount of pressure to the tissue while holding handle 110 of tissue massager 100.

As another example, and not a limitation, as previously described in connection with any of FIGS. 12-20, a user may press rollers 228a-228d of roller assembly 220 of tissue massager 200 against a tissue of the user to provide a first desired amount of pressure to the tissue while holding handle 210 of tissue massager 200.

As another example, and not a limitation, as previously described in connection with any of FIGS. 23-25, a user may press rollers 328a, 328b, 328e of roller assembly 320 of tissue massager 300 against a tissue of the user to provide a first desired amount of pressure to the tissue while holding handle 310 of tissue massager 300.

As another example, and not a limitation, as previously described in connection with any of FIGS. 26-33, a user may press rollers 428a, 428b, 428e of roller assembly 420a of tissue massager 400 against a tissue of the user to provide a first desired amount of pressure to the tissue while holding handle 410 of tissue massager 400.

As another example, and not a limitation, as previously described in connection with any of FIGS. 34-40, a user may press roller 428e of roller assembly 420b of tissue massager 450 against a tissue of the user to provide a first desired amount of pressure to the tissue while holding handle 410 of tissue massager 450.

For clarity, the first desired amount of pressure need not be a single, constant value but may also or alternatively be a changing and/or adaptable amount of pressure based on one or more of a tissue location at which the pressure is being applied, an amount of tension in the tissue to which the pressure is applied, an amount of perceived discomfort or relief by, or of, the user created by the pressure, or any other factor relevant to therapeutic massage of the tissue of the user.

Step 2104 includes rolling the at least one roller along the tissue while the at least one roller is providing the first desired amount of pressure to the tissue while holding the handle of the tissue massager.

For example, and not limitation, as previously described in connection with at least FIGS. 1-8, a user may then roll rollers 128a-128d along the tissue while rollers 128a-128d are providing the first desired amount of pressure to the tissue and while the user is holding handle 110 of tissue massager 100.

Alternatively, as also previously described in connection with at least FIGS. 1-11B a user may then roll rollers 138a-138b of roller assembly 130 of tissue massager 100 along the tissue while rollers 138a-138b are providing the first desired amount of pressure to the tissue and while the user is holding handle 110 of tissue massager 100.

As another example, and not a limitation, as previously described in connection with any of FIGS. 12-20, a user may then roll rollers 228a-228d of roller assembly 220 of tissue massager 200 along the tissue while rollers 238a-238b are providing the first desired amount of pressure to the tissue and while the user is holding handle 210 of tissue massager 200.

As another example, and not a limitation, as previously described in connection with any of FIGS. 23-25, a user may then roll rollers 328a, 328b, 328e of roller assembly 320 of tissue massager 300 along the tissue while rollers 338a-338b are providing the first desired amount of pressure to the tissue and while the user is holding handle 310 of tissue massager 300.

As another example, and not a limitation, as previously described in connection with any of FIGS. 26-33, a user may then roll rollers 428a, 428b, 428e of roller assembly 420a of tissue massager 400 along the tissue while rollers 428a, 428b, 428e are providing the first desired amount of pressure to the tissue and while the user is holding handle 410 of tissue massager 400.

As another example, and not a limitation, as previously described in connection with any of FIGS. 34-40, a user may then roll rollers 428e of roller assembly 420b of tissue massager 450 along the tissue while rollers 428a, 428b, 428e are providing the first desired amount of pressure to the tissue and while the user is holding handle 410 of tissue massager 450.

In some, but not all embodiments, flowchart 2100 further comprises a step 2106, which may include adjusting the orientation of the tissue massager in the user's hand such that a direction of extension of the handle in the user's hand is rotated 180 degrees, end-over-end, compared to an orientation in steps 2102 and/or 2104, thereby placing a second roller assembly in a position to massage the tissue or a different tissue.

For example, and not limitation, as previously described in connection with FIGS. 1-11B, the user may adjust the orientation of tissue massager 100 in his or her hand such that direction of extension 111 of handle 110 in the user's hand is rotated 180 degrees, end-over-end, compared to an orientation in steps 2102 and/or 2104, thereby placing roller assembly 138a-138d in a position to massage the tissue or a different tissue. In some embodiments, the design of massager 100 allows the execution of step 2106 with or without releasing handle 110. Moreover, the design of massager 100 allows the placing of the second roller assembly in the position to massage the tissue or the different tissue by only rotating handle 110 by 180 degrees, end-over-end, compared to an orientation in steps 2102 and/or 2104 without any other rotational adjustment of tissue massager 100 or handle 110 with respect to the user's hand.

In alternative, where the first plurality of rollers are rollers 138a-138d of roller assembly 130, this step may be carried out such that roller assembly 128a-128d is now in a position to massage the first (same) tissue or the different tissue from that massaged in steps 2102, 2104.

In embodiments including step 2106, steps 2102 and 2104 may be repeated using the second roller assembly on the same tissue or a different tissue. For example, such a method may include step 2108, which may include pressing rollers of the second roller assembly of the tissue massager against the same tissue or a different tissue of the user to provide a second desired amount of pressure to the same tissue or to the different tissue while holding the handle of the tissue massager.

For example, and not limitation, roller assembly 138a-138d may be pressed against the same tissue or the different tissue of the user to provide a second desired amount of pressure to the same tissue or to the different tissue while holding handle 110 of tissue massager 100.

Again, for clarity, the second desired amount of pressure need not be a single, constant value but may also or alternatively be a changing and/or adaptable amount of pressure based on one or more of a tissue location at which the pressure is being applied, an amount of tension in the tissue to which the pressure is applied, an amount of perceived discomfort or relief by, or of, the user created by the pressure, or any other factor relevant to therapeutic massage of the tissue of the user.

In alternative, where the second plurality of rollers are rollers 128a-128d of roller assembly 120, rollers 128a-128d may be pressed against the same tissue or the different tissue of the user to provide the second desired amount of pressure to the same tissue or to the different tissue while holding handle 110 of tissue massager 100.

Such a method including steps 2106 and 2108 may also, then, include a step 2110, which may include rolling the second plurality of rollers along the tissue while the rollers are providing the second desired amount of pressure to the same tissue or to the different tissue while holding a handle of the tissue massager.

For example, and not limitation, roller assembly 138a-138d may be rolled along the same tissue or the different tissue while the rollers are providing the second desired amount of pressure to the same tissue or to the different tissue while holding handle 110 of tissue massager 100.

In alternative, where the second plurality of rollers are rollers 128a-128d of roller assembly 120, rollers 128a-128d may be rolled along the same tissue or the different tissue while the rollers are providing the second desired amount of pressure to the same tissue or to the different tissue while holding handle 110 of tissue massager 100.

### Example Method(s) of Manufacture of A Tissue Massager 100, 200, 300, 400, 450

The disclosure now turns to FIG. 22, which illustrates a flowchart 2200 related to a method of manufacturing a tissue massager, e.g., 100, 200, 300, 40, 450, as described anywhere in this disclosure. Although particular steps are described herein, the present application is not so limited and alternative methods may include a subset of these steps, in the same or different order, combined or mixed in any order, and may include one or more addition steps not described herein or below. Moreover, while one or more aspects of an embodiment may be described as carrying out a step, the present disclosure is not so limited and any portion of a step, any step or any grouping of steps are also contemplated to be carried out by a different aspect of an embodiment, or such portions, steps or grouping of steps may be combined in a way such that they are no longer separate steps.

Step 2202a includes forming, by any appropriate means, and as either a singular, monolithic part or as one or more separate parts, each aspect of massager 100, 200, 300, 400 or 450 as described anywhere in this description.

Any one or more of these features of massager 100, 200, 300, 400 or 450 may be formed of any suitable material, including but not limited to, plastic, wood, metal, ceramic, fiberglass, or carbon composite. Moreover, any one or more of these features of massager 100, 200, 300, 400, 450 may be formed utilizing any suitable method, including but not limited to, injection or any other type of molding, milling, machining, stamping, 3D printing, extruding or growing through other repetitive additive process.

Step 2204 includes assembling all separate parts of the massager. For example, any separate pieces formed for tissue massager 100, 200, 300, 400, 450 may be appropriately fixed to one another to form the massager as described anywhere in this disclosure, for example, utilizing any suitable adhesive, melting, potting, fusing, bolting, fasting, clipping or interference fitting process.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1-12. (canceled)

13. A tissue massager, comprising:
a handle having a first direction of extension;
a first roller assembly coupled to a first end of the handle, the first roller assembly comprising a plurality of rollers, each of the plurality of rollers disposed at a different angle with respect to the first direction of extension of the handle; and
a second roller assembly coupled to a second end of the handle opposite the first end, the second roller assembly comprising a plurality of rollers, each of the plurality of rollers disposed at a different angle with respect to the first direction of extension of the handle.

14. The tissue massager of claim 13, wherein the second roller assembly comprises:
a second neck having a third direction of extension and extending from a second end of the handle at a third angle with respect to the first direction of extension;
a first bracket arm coupled to a first side of the second neck, a first roller shaft of the second roller assembly extending laterally from a distal end of the first bracket arm; and a second roller shaft of the second roller assembly extending medially from the distal end of the first bracket arm; and
a second bracket arm coupled to a second side of the second neck opposite the first side, a third roller shaft of the second roller assembly extending medially from a distal end of the second bracket arm and a fourth roller shaft extending laterally from the distal end of the second bracket arm;
each of the plurality of rollers disposed on a respective one of the first, second, third, and fourth roller shafts of the second roller assembly.

15. The tissue massager of claim 14, wherein each of the rollers shafts of the second roller assembly are disposed at a different angle with respect to one another.

16. The tissue massager of claim 13, wherein each of the plurality of rollers has a substantially cylindrical form.

17. (canceled)

18. The tissue massager of claim 14, wherein the second angle at which the second neck extends from the second end of the handle is between 0° and 90°, or between 30° and 60°, or approximately 45°.

19. The tissue massager of claim 14, wherein the second roller assembly has a different size than the first roller assembly, the first roller being sized to massage a first body part and the second roller being sized to massage a second body part having a different size and/or shape compared to the first body part.

20-23. (canceled)

24. A tissue massager, comprising:
a handle;
a roller assembly coupled to a first end of the handle, the roller assembly comprising:
a roller bracket comprising:
a central portion,
a first bracket arm extending from a first side of the central portion and comprising a first bracket arm aperture, and
a second bracket arm extending from a second side of the central portion and comprising a second bracket arm aperture;
a first roller having a first concave surface and disposed to a lateral side of the first bracket arm;
a second roller comprising a second concave surface and disposed to a lateral side of the second bracket arm; and
a third roller comprising a third concave surface and disposed between the first and second bracket arms, wherein each of the first, second and third concave surfaces extend along adjacent portions of a curved path.

25. The tissue massager of claim 24, wherein the first end of the handle has a form factor of approximately one quarter of a ring and substantially planar outward-facing surfaces.

26. The tissue massager of claim 24, wherein the handle comprises a first side fixed to a second side via a plurality of fasteners.

27. The tissue massager of claim 26, wherein:
the first side of the handle comprises a plurality of apertures configured to receive respective ones of the fasteners therethrough; and
the second side of the handle comprises a plurality of threaded apertures, each configured to threadingly receive one of the fasteners.

28. The tissue massager of claim 26, wherein the central portion of the roller bracket is secured between the first and second sides of the handle.

29. The tissue massager of claim 24, wherein the first bracket arm, the second bracket arm, and the central portion of the roller bracket are formed of a single piece.

30. The tissue massager of claim 24, wherein directions of applied pressure for each of the first, second and third rollers converge at a single focal point.

31. The tissue massager of claim 24, wherein:
an outermost side of the first roller has a larger diameter than an innermost side of the first roller;
an outermost side of the second roller may has a larger diameter than an innermost side of the second roller; and
outermost sides of the third roller have a larger diameter than a center of the third roller.

32. The tissue massager of claim 24, wherein the curved path is one of a circular path, a parabolic path and a hyperbolic path.

33. The tissue massager of claim 24, wherein the roller assembly comprises:
a first bushing;
a first roller shaft extending laterally away from a medial surface of the first roller and through the first bushing, wherein at least a portion of the first shaft and at least a portion of the first bushing extend through the first bracket arm aperture, and least an end of the first shaft extends into an axial aperture of the third roller;
a second bushing;
a second roller shaft extending laterally away from a medial surface of the second roller and through the second bushing, wherein at least a portion of the second shaft and at least a portion of the second bushing extend through the second bracket arm aperture, and least an end of the second shaft extends into the axial aperture of the third roller.

34. A tissue massager, comprising:
a handle;
a roller assembly coupled to a first end of the handle, the first roller assembly comprising:
a roller bracket comprising:
a central portion,
a first bracket arm extending from a first side of the central portion and comprising a first bracket arm aperture, and
a second bracket arm extending from a second side of the central portion and comprising a second bracket arm aperture;
a first cap disposed to a lateral side of the first bracket arm;
a second cap disposed to a lateral side of the second bracket arm; and
a roller comprising a concave surface and disposed between the first and second bracket arms, wherein the concave surface extends along a curved path.

35. The tissue massager of claim 34, wherein:
a diameter of the first cap is smaller than an outermost side of the roller; and
a diameter of the second cap is smaller than the outermost side of the roller, such that the first and second caps are not configured to contact a user's tissue when the roller is in contact with the user's tissue.

36. The tissue massager of claim 34, wherein the roller assembly comprises:
a first bushing;
a first roller shaft extending laterally away from a medial surface of the first cap and through the first bushing, wherein at least a portion of the first shaft and at least a portion of the first bushing extend through the first bracket arm aperture, and least an end of the first shaft extends into an axial aperture of the roller;
a second bushing;
a second roller shaft extending laterally away from a medial surface of the second cap and through the second bushing, wherein at least a portion of the second shaft and at least a portion of the second bushing extend through the second bracket arm aperture, and least an end of the second shaft extends into the axial aperture of the roller.
